(19) United States
(12) Patent Application Publication
(10) Pub. No.: US 2026/0099932 A1
(43) Pub. Date: Apr. 9, 2026

(54) INFORMATION PROCESSING APPARATUS, INFORMATION PROCESSING METHOD, AND STORAGE MEDIUM STORING INFORMATION PROCESSING PROGRAM

(71) Applicant: Keyence Corporation, Osaka (JP)

(72) Inventor: Woobum KANG, Osaka (JP)

(73) Assignee: Keyence Corporation, Osaka (JP)

(21) Appl. No.: 19/314,079

(22) Filed: Aug. 29, 2025

(30) Foreign Application Priority Data
Oct. 7, 2024 (JP) 2024-175782

(51) Int. Cl. G06T 7/521; G06T 7/68; G06T 7/73; G06V 10/75; G06V 20/64

(52) U.S. Cl. CPC G06T 7/521; G06T 7/68; G06T 7/73; G06V 10/757; G06V 20/64; G06T 2207/10028; G06T 2207/30164

(57) ABSTRACT

To automatically set a reference coordinate system for analysis from three-dimensional data to reduce the burden on users during analysis. The information processing apparatus comprises: a data acquisition unit that acquires three-dimensional data of a workpiece; an extraction unit that extracts geometric elements from the three-dimensional data of the workpiece acquired by the data acquisition unit; a type identification unit that identifies the type of geometric elements extracted by the extraction unit; a coordinate system setting unit that identifies one rule from a previously stored rule set based on the type of geometric element identified by the type identification unit, and sets a reference coordinate system based on the identified rule and the geometric elements; and an analysis unit that performs analysis of the three-dimensional data of the workpiece based on the reference coordinate system set by the coordinate system setting unit.

### CROSS-REFERENCE TO RELATED APPLICATIONS

The present application claims foreign priority based on Japanese Patent Application No. 2024-175782, filed Oct. 7, 2024, the contents of which are incorporated herein by reference.

### BACKGROUND OF THE INVENTION

### 1. Technical Field

The present disclosure relates to an information processing apparatus, an information processing method, and a storage medium storing an information processing program for analyzing three-dimensional data of a workpiece.

### 2. Description of the Related Art

For example, JP 2024-24328 A discloses a three-dimensional scanner that scans a workpiece placed on a stage to generate three-dimensional data.

This type of three-dimensional scanner is mainly configured to project structured illumination light onto a workpiece on the stage, and to measure the three-dimensional shape of the workpiece by capturing and analyzing the distortion of the illumination light with a camera.

### SUMMARY OF THE INVENTION

By the way, there are cases where three-dimensional data obtained by a three-dimensional scanner such as in JP 2024-24328 A is analyzed. To analyze three-dimensional data, a reference coordinate system is necessary, but the three-dimensional data obtained by the three-dimensional scanner is displayed in the device coordinate system, which is different from the reference coordinate system that the user wants to analyze. Therefore, the user needs to separately set a reference coordinate system.

In other words, when determining the reference coordinate system, planes, cylinders, cones, etc. that serve as references are specified from the workpiece, and normal vectors of planes, central axes of cylinders, central axes of cones, etc. are used as reference axes, which are used to determine the coordinate system. After determining the reference axes, the user cuts cross sections along the reference axes or projects onto the reference planes to create two-dimensional representations, and then measures and analyzes the width, angle, etc. of each part of the workpiece.

If there is an error in the reference axis, the analysis results will of course be inaccurate, so setting an accurate reference axis as pre-processing for analysis is an essential process. However, the reference axis needs to be set for each three-dimensional data being analyzed, which is particularly cumbersome when repeatedly analyzing workpieces of similar shapes. In addition, for beginners in analysis, the concept of setting a reference axis itself is difficult to understand and is not a simple task. Furthermore, when trying to automate repetitive measurement tasks, setting the reference axis becomes a barrier.

The present disclosure is made in view of such points, and its objective is to automatically set a coordinate system that serves as a reference during analysis from three-dimensional data, thereby reducing the burden on the user required for analysis.

To achieve the above objective, one aspect of the present disclosure can be premised on an information processing apparatus that analyzes three-dimensional data of a workpiece with a predetermined coordinate system set. The information processing apparatus comprises: a storage unit that stores in advance a rule set associating types of a plurality of geometric elements used for creating a coordinate system with information for creating a coordinate system based on geometric elements of each type; a data acquisition unit that acquires the three-dimensional data of the workpiece; an extraction unit that extracts geometric elements from the three-dimensional data of the workpiece acquired by the data acquisition unit; a type identification unit that identifies types of the geometric elements extracted by the extraction unit; a coordinate system setting unit that identifies one rule from the rule set stored in the storage unit based on the types of the geometric elements identified by the type identification unit, and sets a reference coordinate system based on the identified one rule and the geometric elements extracted by the extraction unit; and an analysis unit that performs analysis of the three-dimensional data of the workpiece based on the reference coordinate system set by the coordinate system setting unit.

With this configuration, when geometric elements included in three-dimensional data acquired by the data acquisition unit are extracted by the extraction unit, the type of the extracted geometric elements is identified by the type identification unit. Based on the identified type of geometric elements, a rule that associates the type of geometric elements with coordinate system information is identified. Since the coordinate system setting unit automatically sets the reference coordinate system based on this rule and the geometric elements, the user does not need to set a reference coordinate system during analysis. In addition, the reference coordinate system set in this way utilizes geometric elements included in the three-dimensional data, so it has high precision and becomes a coordinate system suitable for analysis.

In another aspect of the present disclosure, an information processing method for analyzing three-dimensional data of a workpiece with a predetermined coordinate system set can also be assumed. In the information processing method, a rule set associating a plurality of types of geometric elements used for creating a coordinate system with information for creating a coordinate system based on each type of geometric element is stored in advance in a storage unit, three-dimensional data of the workpiece is acquired, geometric elements are extracted from the acquired three-dimensional data of the workpiece, types of the extracted geometric elements are identified, a rule is identified from among the rule set stored in the storage unit based on the identified types of geometric elements, a reference coordinate system is set based on the identified one rule and the extracted geometric elements, and analysis of the three-dimensional data of the workpiece is performed based on the set reference coordinate system.

In yet another aspect of the present disclosure, a storage medium storing an information processing program for causing a computer to execute information processing for analyzing three-dimensional data of a workpiece with a predetermined coordinate system set can be provided. For example, the information processing program causes a computer having a storage unit in which a rule set associating a plurality of types of geometric elements used for creating a coordinate system with information for creating a coordinate system based on each type of geometric elements, a processor, and a memory storing an information processing program configured to be executed by the processor, the information processing program including instructions for: acquiring three-dimensional data of the workpiece; extracting geometric elements from the acquired three-dimensional data of the workpiece; identifying types of the extracted geometric elements; identifying one rule from the rule set stored in the storage unit based on the identified types of geometric elements; setting a reference coordinate system based on the identified rule and the extracted geometric elements; and performing analysis of the three-dimensional data of the workpiece based on the set reference coordinate system.

In addition, the information processing apparatus may be provided with a storage unit that stores a model for identifying a combination of analysis menus used for analyzing three-dimensional data from among multiple analysis menus prepared in advance based on the shape of the three-dimensional data of the workpiece, a candidate identification unit that identifies candidate combinations of analysis menus used for analyzing three-dimensional data from among multiple analysis menus prepared in advance based on the shape of the three-dimensional data acquired by the data acquisition unit and the model stored in the storage unit, a display control unit that causes the display unit to display the combination of analysis menus identified by the candidate identification unit, and an analysis unit that performs shape analysis of the workpiece based on the analysis menus identified by the candidate identification unit.

As described above, it is possible to automatically set a coordinate system that serves as a reference during analysis from three-dimensional data of the workpiece, thereby reducing the burden on the user for analysis.

### BRIEF DESCRIPTION OF THE DRAWINGS

FIG. 1 is a diagram showing the overall configuration of a three-dimensional scanner according to an embodiment of the present disclosure.

FIG. 2 is a block diagram of the three-dimensional scanner.

FIG. 3 is a side view of the measuring unit and the base unit.

FIG. 4 is a block diagram of the measuring unit.

FIG. 5 is a diagram showing an example of the module configuration.

FIG. 6 is a flowchart showing an example of the reference coordinate system setting process.

FIG. 7 is a diagram explaining the process of extracting a plane from three-dimensional data of a workpiece.

FIG. 8 is a diagram explaining the estimation method for the first reference axis and the first provisional origin.

FIG. 9 is a diagram explaining the estimation method for the second reference axis.

FIG. 10 is a diagram explaining the method for estimating the second reference axis based on the second plane.

FIG. 11 is a diagram explaining the estimation method for the third reference axis.

FIG. 12 is a diagram explaining the estimation method for the second provisional origin.

FIG. 13 is a diagram explaining the estimation method for the third plane.

FIG. 14 is a diagram explaining the method for setting the origin.

FIG. 15 is a diagram showing an example where a three-dimensional shape is extracted as geometric elements.

FIG. 16 is a diagram explaining the method for setting a reference coordinate system based on extracted cylinders.

FIG. 17 is a diagram explaining the method for setting a reference axis by extracting a symmetry plane.

FIG. 18 is a flowchart for setting a reference coordinate system based on multiple types of geometric elements.

FIG. 19 is a diagram showing an example of a screen displayed when proposing measurement items.

FIG. 20 is a diagram showing another example of a screen displayed when proposing measurement items.

FIG. 21 is a figure equivalent to FIG. 20 when the cursor position is on the geometric tolerance menu.

FIG. 22 is a diagram showing an example of a screen displayed when cross section measurement and three-dimensional measurement are selected.

FIG. 23 is a diagram showing an example of a cross section measurement result screen.

FIG. 24 is a diagram showing a second example of a cross section measurement result screen.

FIG. 25 is a diagram showing an example of a three-dimensional measurement result screen.

FIG. 26 is a diagram showing an example of executing cross section measurement on CAD data.

### DETAILED DESCRIPTION

The embodiments of the present disclosure will be described in detail below based on the drawings. The following description of the preferred embodiments is essentially illustrative only and is not intended to limit the present disclosure, its applications, or its uses.

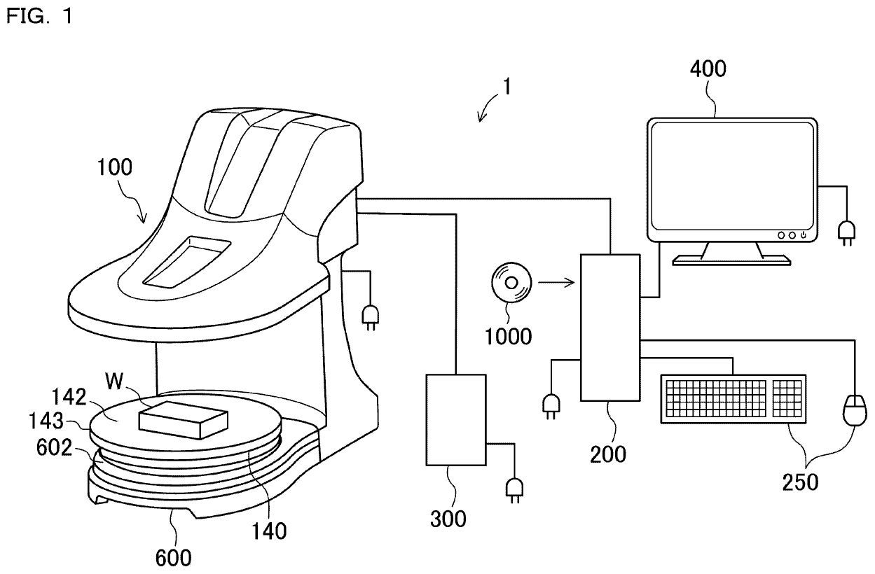

FIG. 1 is a diagram showing the overall configuration of a three-dimensional scanner 1 as an information processing apparatus according to an embodiment of the present invention. The three-dimensional scanner 1 is configured to be capable of acquiring three-dimensional data by measuring the shape of a workpiece (measurement target) W and converting it into mesh data of the workpiece W for output, and is also configured to be capable of analyzing the three-dimensional data of the workpiece W. In addition, the three-dimensional scanner 1 is capable of converting the mesh data of the workpiece W into CAD data for output, and also of converting the mesh data into surface data for output.

In the following description, when measuring the shape of a workpiece W, to obtain coordinate information of the workpiece W surface, predetermined patterned measurement light is irradiated onto the workpiece W, and the coordinate information is obtained using signals obtained from the reflected light reflected from the surface of the workpiece W. For example, as the predetermined patterned measurement light, structured illumination can be used to project onto the workpiece W, and a measurement method using triangulation based on the fringe projection image obtained from its reflected light can be used. However, in the present disclosure, the principle and configuration for obtaining coordinate information of the workpiece W are not limited to this, and other methods can also be applied.

The three-dimensional scanner 1 includes a measuring unit 100 that measures the shape of the workpiece W, a base unit 600 on which the workpiece W can be placed, a controller 200, a light source unit 300, and a display unit 400. The controller 200 may be incorporated into the measuring unit 100, the light source unit 300 may be incorporated into the measuring unit 100, or the display unit 400 may be incorporated into the measuring unit 100. Also, the controller 200 and the light source unit 300 may be integrated, or the controller 200 and the display unit 400 may be integrated.

In this embodiment, a case where an information processing apparatus is configured by the three-dimensional scanner 1 will be described, but alternatively, for example, the information processing apparatus may be configured only with the controller 200, or with the controller 200 and the display unit 400. In other words, the measuring unit 100, the base unit 600, and the light source unit 300 may each be provided as needed.

The three-dimensional scanner 1 can perform structured illumination on the workpiece W with the light source unit 300, capture fringe projection images to generate depth images with coordinate information, and based on this, measure the three-dimensional dimensions and shape of the workpiece W. Such measurement using fringe projection has the advantage that three-dimensional measurement can be performed without moving the workpiece W or optical system such as lenses in the Z direction (height direction), thereby shortening the measurement time.

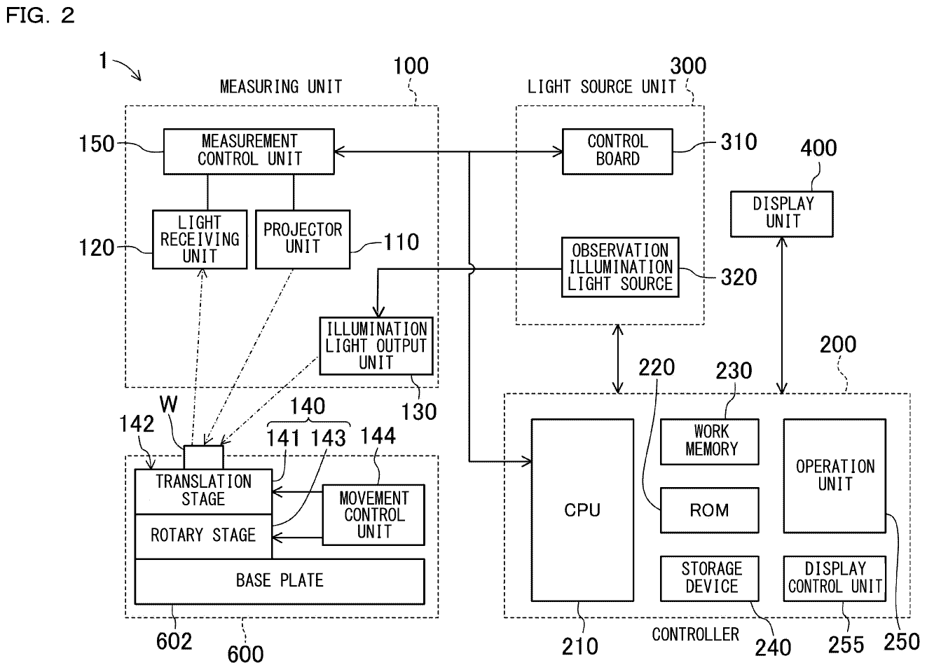

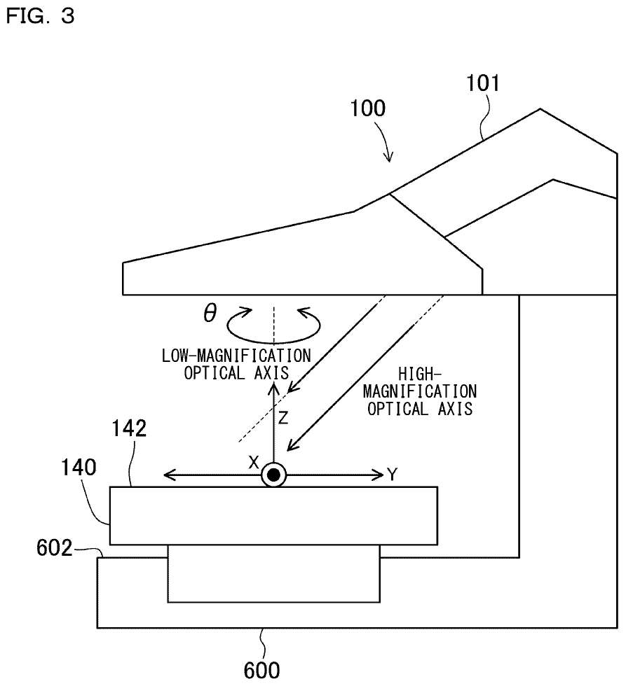

FIG. 2 shows a block diagram of the three-dimensional scanner 1. As shown in this figure, the measuring unit 100 includes a pattern light projector unit (first projector unit) 110 that projects a measurement pattern light onto the workpiece W, a light receiving unit 120, a measurement control unit 150, and an illumination light output unit 130. The projector unit 110 is a portion that irradiates measurement light having a predetermined pattern onto the workpiece W placed on the placement unit 140 described later. Placing the workpiece W on the placement unit 140 and positioning the workpiece W on the placement unit 140 are the same thing.

The light receiving unit 120 is fixed in an inclined posture with respect to the placement surface 142 that the rotary stage 143, to be described later, has. The light receiving unit 120 receives the measurement light that is irradiated by the projector unit 110 and reflected by the workpiece W. When the light receiving unit 120 receives the measurement light as reflected light from the workpiece W, it generates and outputs a first reception signal for measurement representing the amount of received measurement light. The light receiving unit 120 can generate an observation image for observing the overall shape of the workpiece W by imaging the workpiece W placed on the placement unit 140. In this example, although there is an illumination light output unit 130, uniform light may be irradiated onto the workpiece W from the projector unit 110. In this case, the projector unit 110 is a member that irradiates the measurement light and the uniform light onto the workpiece W at different timings. The light receiving unit 120 can also receive uniform light irradiated from the projector unit 110 and output a second reception signal for texture acquisition. For example, uniform light of the same wavelength as the measurement light can be irradiated from the measurement light source, and a reception signal containing color information of one axis can be output. In addition, although not shown, a calibrated first camera and second camera can be prepared, with the first camera acquiring the shape and the second camera acquiring texture information. The texture information includes color information and luminance information of the workpiece W.

The light receiving unit 120 according to the present embodiment includes a high-magnification light receiving unit and a low-magnification light receiving unit. The high-magnification light receiving unit is a part that can capture an image of the workpiece W with greater magnification compared to the low-magnification light receiving unit. On the other hand, the low-magnification light receiving unit is a light receiving unit with a wider field of view compared to the high-magnification light receiving unit.

The base unit 600 includes a base plate 602, a mounting unit 140, and a movement control unit (stage control unit) 144. The mounting unit 140 is supported on the base plate 602 of this base unit 600. The movement control unit 144 is a portion that controls the movement and rotation of the rotary stage 143 on which the workpiece W is placed. The movement control unit 144 may be provided either on the base unit 600 side or on the controller 200 side.

The light source unit 300 is connected to the measuring unit 100. The light source unit 300 is a part that generates measurement light and supplies it to the measuring unit 100. The controller 200 is a part that controls the measuring unit 100 and other components. The display unit 400 is connected to the controller 200 and is configured to display images generated by the measuring unit 100, and also to allow necessary settings, inputs, selections, etc.

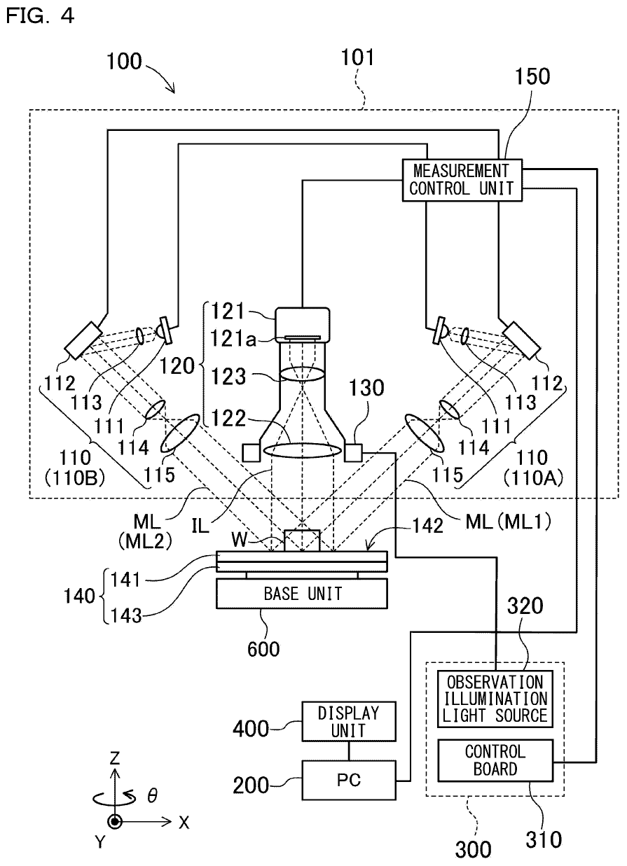

The placement unit 140 has a rotary stage 143 with a placement surface 142 formed on its upper surface, on which the workpiece W is placed. As shown in FIG. 4, as the device coordinate system, two directions that are orthogonal to each other within the placement surface 142 of the rotary stage 143 are defined as the X direction and Y direction, and are indicated by arrows X and Y, respectively. The direction perpendicular to the placement surface 142 of the placement unit 140 is defined as the Z direction, and is indicated by arrow Z. The direction of rotation around an axis parallel to the Z direction is defined as the 0 direction, and is indicated by arrow θ.

The mounting part 140 includes a rotary stage 143 that rotates the mounting surface 142 around an axis extending in the Z direction, and a translation stage 141 that moves the mounting surface 142 in the horizontal direction (X direction, Y direction). The translation stage 141 has an X-direction movement mechanism and a Y-direction movement mechanism. The rotary stage 143 has a θ-direction rotation mechanism. The mounting part 140 may include a fixing member (clamp) that fixes the workpiece W to the mounting surface 142. Furthermore, the mounting part 140 may include a tilt stage having a mechanism capable of rotating around an axis parallel to the mounting surface 142.

The movement control unit 144 controls the rotary movement of the rotary stage 143 and the parallel movement of the translation stage 141 according to the measurement conditions set by the measurement condition setting unit 261 to be described later. Also, the movement control unit 144 controls the movement operation of the mounting part 140 by the mounting moving part based on the measurement region set by the measurement condition setting unit 261 to be described later.

The controller 200 includes a CPU (Central Processing Unit) 210, ROM (Read Only Memory) 220, work memory 230, storage device (storage unit) 240, and operation unit 250. A PC (personal computer) or the like can be used as the controller 200.

The configuration of the measuring unit 100 is shown in the block diagram of FIG. 4. The measuring unit 100 includes a projector unit 110, a light receiving unit 120, an illumination light output unit 130, a measurement control unit 150, and a main case 101 that houses these components. The projector unit 110 includes a measurement light source 111, a pattern generation unit 112, and multiple lenses 113, 114, 115. The light receiving unit 120 includes a camera 121 and multiple lenses 122, 123. In the case where measurements are conducted at different magnifications by providing multiple light receiving units, the measuring unit may be equipped with a light receiving unit 120a comprising a camera 121 for low magnification and lenses for low magnification, and a light receiving unit 120b comprising a camera 121 for high magnification and lenses for high magnification. This configuration is not limiting; magnification may be made variable by switching between multiple lenses for a single camera 121, or magnification may be made variable by providing a zoom lens for a single camera 121.

The projector unit 110 is arranged obliquely above the placement unit 140. In the example shown in FIG. 4, the measuring unit 100 includes two projector units 110, but the measuring unit 100 may include a plurality of projector units 110. Here, a first measurement light projection unit 110A (right side in FIG. 4) capable of irradiating a first measurement light ML1 to the workpiece W from a first direction, and a second measurement light projection unit 110B (left side in FIG. 4) capable of irradiating a second measurement light ML2 to the workpiece W from a second direction different from the first direction are provided respectively. The first measurement light projection unit 110A and the second measurement light projection unit 110B are arranged symmetrically with the optical axis of the light receiving unit 120 as the center of symmetry. Although not shown, it is also possible to provide three or more projector units 110, or to relatively move the projector unit 110 and the placement unit 140 to project light onto the workpiece W with different illumination directions while using a common projector unit 110. In the above example, multiple projector units 110 are prepared and a common light receiving unit 120 receives light, but conversely, the configuration may be such that a common projector unit 110 is used with multiple light receiving units 120 prepared to receive light. Furthermore, in this example, the irradiation angle of the illumination light projected by the projector unit 110 with respect to the Z direction is fixed, but this can also be made variable.

Each first measurement light projection unit 110A and second measurement light projection unit 110B includes a measurement light source 111 as a first measurement light source and a second measurement light source, respectively. These measurement light sources 111 are, for example, halogen lamps that emit white light. The measurement light source 111 may be a light source that emits monochromatic light, for example, a blue LED (light-emitting diode) that emits blue light, an organic EL, or other light sources. The light emitted from the measurement light source 111 (hereinafter referred to as “measurement light”) is appropriately focused by the lens 113 and then incident on the pattern generation unit 112.

The central axis of the projector unit 110A, 110B and the central axis of the light receiving unit 120 intersect at a position where the placement of the workpiece W on the base unit 140 and the depth of field of the projector unit 110 and the light receiving unit 120 are appropriate, and the relative positional relationship between the light receiving unit 120, the projector unit 110A, 110B, and the base unit 140 is determined accordingly. In addition, since the center of the rotation axis in the 0 direction coincides with the central axis of the light receiving unit 120, when the base unit 140 rotates in the 0 direction, the workpiece W does not move out of the field of view and rotates within the field of view around the rotation axis.

The pattern generation unit 112 reflects light emitted from the measurement light source 111 so as to project measurement light onto the workpiece W. The measurement light incident on the pattern generation unit 112 is converted into a predetermined pattern and predetermined intensity (brightness) before being emitted. The measurement light emitted by the pattern generation unit 112 is converted by multiple lenses 114, 115 into light having a diameter larger than the observable and measurable field of view of the light receiving unit 120, and then irradiated onto the workpiece W on the mounting unit 140.

The pattern generation unit 112 is a member capable of switching between a projection state in which measurement light is projected onto the workpiece W and a non-projection state in which measurement light is not projected onto the workpiece W. A DMD (digital micromirror device) and the like can be used as such a pattern generation unit 112. The pattern generation unit 112 using a DMD can be controlled by the measurement control unit 150 to switch between a reflection state as a projection state in which measurement light is reflected onto the optical path and a light-blocking state as a non-projection state in which measurement light is blocked.

The DMD is a device in which a large number of micromirrors (small mirror surfaces) are arranged on a plane. Each micromirror can be individually switched between ON and OFF states by the measurement control unit 150, so desired projection patterns can be configured by combining the ON and OFF states of the numerous micromirrors. This enables the generation of patterns necessary for triangulation, making it possible to measure the shape of the workpiece W. In this way, the DMD functions as a projection pattern optical system that projects periodic measurement patterns onto the workpiece W during measurement. The DMD also excels in response speed, providing the advantage of being able to operate at higher speeds compared to shutters and similar devices.

While in the above example, an explanation has been given for a case where a DMD is used for the pattern generation unit 112, the present invention is not limited to using a DMD for the pattern generation unit 112, and other components may be used. For example, LCOS (Liquid Crystal on Silicon: reflective liquid crystal device) may be used as the pattern generation unit 112. Alternatively, instead of a reflective component, a transmissive component may be used to adjust the amount of measurement light transmitted. In this case, the pattern generation unit 112 is arranged on the optical path of the measurement light to switch between a projection state where the measurement light is transmitted and a light-shielding state where the measurement light is blocked. For such a pattern generation unit 112, for example, an LCD (liquid crystal display) can be used. Alternatively, the pattern generation unit 112 may be configured using a projection method using multiple-line LED, a projection method using multiple optical paths, an optical scanner system consisting of a laser and a galvano mirror, etc., an AFI (Accordion fringe interferometry) method that uses interference fringes generated by overlapping beams divided by a beam splitter, or a projection method using a physical grid and movement mechanism configured with a piezo stage and a high-resolution encoder, etc.

The light receiving unit 120 is disposed above the placement unit 140. The measurement light reflected upward from the placement unit 140 by the workpiece W is converged and focused by a plurality of lenses 122, 123 of the light receiving unit 120, and then received by the camera 121.

The camera 121 is, for example, a CCD (Charge Coupled Device) camera including an imaging element 121a. The imaging element 121a is, for example, a monochrome CCD (Charge Coupled Device). The imaging element 121a may be another imaging element such as a CMOS (Complementary Metal Oxide Semiconductor) image sensor. A color imaging element requires each pixel to correspond to red, green, and blue light reception, resulting in lower measurement resolution compared to a monochrome imaging element, and also requires color filters for each pixel, which reduces sensitivity. Therefore, in this embodiment, a monochrome CCD is adopted as the imaging element, and a color image is acquired by time-division projection of illumination corresponding to RGB from the illumination light output unit 130, which will be described later. With such a configuration, it is possible to obtain a color image of the measurement object without decreasing the measurement precision. The illumination light output unit 130 is an example of a second projector unit that projects illumination light onto the workpiece W. The illumination light can be uniform light.

Moreover, a color imaging element may be used as the imaging element 121a. In this case, although the measurement precision and sensitivity decrease compared to a monochrome imaging element, it becomes unnecessary to emit illumination corresponding to RGB in time division from the illumination light output unit 130, and a color image can be obtained by simply emitting white light, allowing the illumination optical system to be configured simply. An analog electrical signal (hereinafter referred to as a “reception signal”) corresponding to the amount of received light is output from each pixel of the imaging element 121a to the measurement control unit 150.

The measurement control unit 150 has an A/D converter (analog/digital converter) and a FIFO (First In First Out) memory, which are not shown, implemented therein. The light reception signal output from the camera 121 is sampled at a constant sampling cycle by the A/D converter of the measurement control unit 150 based on the control by the light source unit 300, and is converted into a digital signal. The digital signal output from the A/D converter is sequentially accumulated in the FIFO memory. The digital signal accumulated in the FIFO memory is sequentially transferred to the controller 200 as pixel data.

The operation unit 250 of the controller 200 can include, for example, a keyboard and a pointing device. As the pointing device, a mouse or joystick, for example, can be used.

In the ROM 220 of the controller 200, system programs and the like are stored. The work memory 230 of the controller 200 consists of, for example, RAM (Random Access Memory) and is used for processing various data. The storage device 240 consists of a solid-state drive, hard disk drive, etc. The storage device 240 stores an information processing program for causing the controller (computer) 200 to execute the reference coordinate system setting process and analysis process to be described later.

Furthermore, the storage device 240 is used to store various data such as pixel data (image data), setting information, measurement conditions, rules for coordinate system setting, etc., provided by the measurement control unit 150. The measurement conditions include, for example, settings of the projector unit 110 (pattern frequency, pattern type), and the type of light receiving unit 120 (low-magnification light receiving unit, high-magnification light receiving unit), and various other settings that are configured in the scanner module 260 to be described later when measuring the shape of the workpiece W. Additionally, the storage device 240 can store brightness information, coordinate information, and attribute information for each pixel constituting the measurement image.

The CPU 210 is a control circuit or control element that processes given signals and data, performs various calculations, and outputs the calculation results. In this specification, CPU refers to an element or circuit that performs calculations, and regardless of its name, is not limited to processors such as general-purpose PC CPUs, MPUs, GPUs, TPUs, etc., but is used to include processors such as FPGAs, ASICs, LSIs, or microcontrollers, or chipsets such as SoCs.

The CPU 210 generates image data based on the pixel data provided from the measurement control unit 150. In addition, the CPU 210 performs various processes on the generated image data using the work memory 230. For example, the CPU 210 generates measurement data representing the three-dimensional shape of the workpiece W included in the field of view of the light receiving unit 120 at a specific position of the placement unit 140 based on the light reception signal output from the light receiving unit 120. The measurement data is the image itself acquired by the light receiving unit 120, and for example, when measuring the shape of the workpiece W by the phase shift method, multiple images will constitute one set of measurement data. Furthermore, the measurement data may be point cloud data which is a collection of points having three-dimensional position information, and the measurement data of the workpiece W can be obtained with this point cloud data. The point cloud data is data expressed as an aggregate of multiple points having three-dimensional coordinates.

The movement control unit 144 determines whether to execute only the rotational movement of the rotary stage 143, or both the rotational movement of the rotary stage 143 and the parallel movement of the translation stage 141, based on measurement data of at least a part of the workpiece W. As a result, three-dimensional measurement becomes easier by automatically determining the imaging range according to the external shape of the workpiece W without the user having to be conscious of it. Furthermore, the movement control unit 144 can control the rotary stage 143 to rotate while the translation stage 141 is stopped in the XY direction after moving in the XY direction, thereby enabling the acquisition of the shape around the workpiece W. In addition, scanning can also be performed by fixing the measuring unit 100 in position and moving and rotating the workpiece W relative to the measuring unit 100.

The display unit 400 is a member for displaying fringe projection images acquired by the measuring unit 100, depth images generated based on the fringe projection images, or texture images captured by the measuring unit 100, various user interface screens, etc. The display unit 400 is configured, for example, by an LCD panel or an organic EL (electroluminescence) panel. Furthermore, by utilizing a touch panel for the display unit 400, it can serve concurrently as the operation unit 250. The display unit 400 is also capable of displaying images generated by the light receiving unit 120.

The light source unit 300 includes a control substrate 310 and an observation illumination light source 320. A CPU (not shown) is mounted on the control substrate 310. The CPU of the control substrate 310 controls the projector unit 110, the light receiving unit 120, and the measuring unit 150 based on instructions from the CPU 210 of the controller 200. This configuration is just an example, and other configurations may be used. For example, the control substrate may be omitted by having the measuring unit 150 control the projector unit 110 and the light receiving unit 120, or by having the controller 200 control the projector unit 110 and the light receiving unit 120. Alternatively, a power supply circuit for driving the measuring unit 100 may be provided in this light source unit 300.

The observation illumination light source 320 includes, for example, three LED colors that emit red light, green light, and blue light. By controlling the luminance of light emitted from each LED, light of any color can be generated from the observation illumination light source 320. The illumination light IL generated from the observation illumination light source 320 is output from the illumination light output unit 130 of the measuring unit 100 through a light guide member (light guide). In addition to LEDs, other light sources such as semiconductor lasers (LD), halogen lights, HID, etc. can also be appropriately used for the observation illumination light source. Especially when using an imaging element capable of color imaging as the imaging element, a white light source can be used for the observation illumination light source.

The illumination light IL output from the illumination light output unit 130 is irradiated on the workpiece W by switching between red light, green light, and blue light in a time-division manner. As a result, texture images captured by these RGB lights respectively can be combined to obtain a color texture image, which can be displayed on the display unit 400.

An information processing program including three-dimensional measurement programs and applications for implementing the coordinate system setting function and analysis function of the three-dimensional scanner 1 by the controller 200 is installed in the controller 200. This enables the information processing method according to the present disclosure to be executed using the three-dimensional scanner 1. The information processing method is a method for analyzing three-dimensional data of a workpiece W in which a predetermined coordinate system is set, and specifically, it is executed by a computer included in the controller 200. The information processing program for causing a computer to execute the information processing method can be stored in a storage medium 1000. The storage medium 1000 may be an optical disk such as a CD-ROM or DVD-ROM, or may be a semiconductor memory such as a memory card.

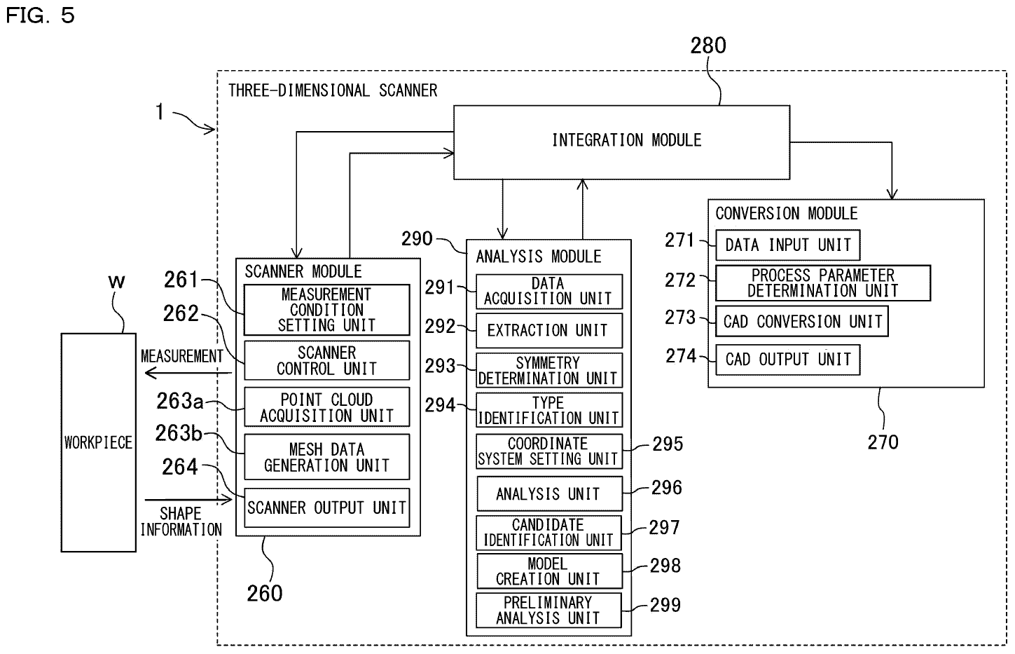

In the controller 200 where the information processing program is installed, the scanner module 260, conversion module 270, integration module 280, and analysis module 290 shown in FIG. 5 are configured by the CPU 210, ROM 220, work memory 230, storage device 240, etc. In this embodiment, the modules are divided into four modules: scanner module 260, conversion module 270, integration module 280, and analysis module 290, but any two or more of these modules 260, 270, 280, 290 may be integrated to constitute a single module. Also, a part of each module 260, 270, 280, 290 may be incorporated into another module. That is, the configuration example shown in FIG. 5 is just an example and is not limited to the configuration example shown in FIG. 5.

The scanner module 260 is a part that acquires image data of the workpiece W by measuring the shape of the workpiece W, and creates mesh data of the workpiece W based on the image data. The conversion module 270 is a part that converts the mesh data created by the scanner module 260 into CAD data. The CAD data is three-dimensional shape information composed of analytical surfaces and free-form surfaces, and includes surface data, solid data, data used for design, and the like. Surface data is data of shape surfaces composed of free-form surfaces and analytical surfaces, such as cylindrical side surface data, plane data, etc.

The integration module 280 is a part that transmits signals and data from the scanner module 260 to the conversion module 270 and the analysis module 290, and transmits signals and data from the conversion module 270 to the scanner module 260. In this example, a module refers to something that can execute multiple arithmetic processes as a single unit, and can also be called a function unit, a function block, etc.

The scanner module 260 has, for example, a measurement condition setting unit 261, a scanner control unit 262, a point cloud acquisition unit 263a, a mesh data generation unit 263b, a scanner output unit 264, and the like. The measurement condition setting unit 261 is a part that sets measurement conditions for the shape of the workpiece. The scanner control unit 262 is a part that controls the measuring unit 100 according to the measurement conditions set by the measurement condition setting unit 261 to generate image data, and acquires measurement data of the workpiece W based on the generated image data.

The point cloud acquisition unit 263a is a part that acquires point cloud data of the workpiece W based on the image data of the workpiece W acquired by the scanner control unit 262. The mesh data generation unit 263b acquires the point cloud data acquired by the point cloud acquisition unit 263a, processes the acquired point cloud data, and converts it to mesh data.

The scanner output unit 264 is a portion that outputs the mesh data created by the mesh data generation unit 263b and additional data to the conversion module 270. The additional data is, for example, data that includes at least one of the measurement condition and data calculated from the measurement data of the workpiece W.

The scanner module 260 controls the measuring unit 100 and generates three-dimensional data along with various conditions under which the shape measurement of the workpiece W was performed (such as the measurement model, measurement magnification, resolution, etc.) and the raw data at the time of measurement (such as image data, etc.). The three-dimensional data is mesh data containing a plurality of polygons, which can also be called polygon data. A polygon is data composed of information specifying multiple points and information indicating a polygonal face formed by connecting those points; for example, it can be composed of information specifying three points and information indicating a triangular face formed by connecting those three points. Mesh data and polygon data can also be defined as data represented by an aggregate of multiple polygons.

In the conversion module 270, mesh data is converted to CAD data, and this conversion process is determined based on measurement conditions and raw data. Specifically, the conversion module 270 includes, for example, a data input unit 271, a process parameter determination unit 272, a CAD conversion unit 273, a CAD output unit 274, etc. The data input unit 271 is a part that accepts mesh data output from the scanner output unit 264 and additional data. The process parameter determination unit 272 is a part that determines the processing parameters for converting mesh data to CAD data according to the additional data accepted by the data input unit 271. The CAD conversion unit 273 is a part that converts mesh data to CAD data according to the processing parameters determined by the process parameter determination unit 272. The CAD output unit 274 is a part that outputs the CAD data converted by the CAD conversion unit 273.

The analysis module 290 of the three-dimensional scanner 1 sets a reference coordinate system for performing analysis by the user as a coordinate system of the three-dimensional data of the workpiece W generated by the scanner module 260, and performs analysis of the three-dimensional data of the workpiece W based on the set reference coordinate system. In other words, the coordinate system of the three-dimensional data of the workpiece W generated by the scanner module 260 is the device coordinate system, and this device coordinate system is, for example, a coordinate system based on the lens origin of the scanner head constituting the measuring unit 100, or a coordinate system based on the rotation center of the rotary stage 143, which is different from the reference coordinate system that serves as a reference when the user analyzes the three-dimensional data. In this embodiment, the three-dimensional scanner 1 has a setting function in which the analysis module 290 automatically sets a reference coordinate system for the three-dimensional data of the workpiece W without the user having to set a reference coordinate system for the three-dimensional data of the workpiece W.

In order to enable automatic setting of a reference coordinate system, the analysis module 290 is provided with a data acquisition unit 291, an extraction unit 292, a symmetry determination unit 293, a type identification unit 294, a coordinate system setting unit 295, an analysis unit 296, a candidate identification unit 297, a model creation unit 298, and a preliminary analysis unit 299. Also, the analysis module 290 is provided with an analysis unit 296 that performs analysis of three-dimensional data of the workpiece W after automatic setting of the reference coordinate system.

As will be described in detail later, when creating a reference coordinate system to be used for analysis, one or more geometric elements included in the three-dimensional data of the workpiece W are used. The geometric elements used when creating a reference coordinate system include, for example, at least one of a plane and a three-dimensional shape. The three-dimensional shape includes, for example, a cylinder, a cone, etc. Thus, it is possible to use multiple types of different geometric elements for coordinate system creation, and there are types of geometric elements such as the aforementioned plane, three-dimensional shape (cylinder, cone), etc. And, the coordinate system creation method and creation rules differ for each different type of geometric element. Corresponding to this, the storage device 240 of this embodiment stores a rule set that associates the types of multiple geometric elements used for creating a coordinate system with the information for creating a coordinate system based on each type of geometric element. The information of the coordinate system includes, for example, the coordinate system creation method and creation rules. For example, when the geometric element is a plane, a first rule is determined by associating the creation method and creation rules of the coordinate system created based on the plane. Also, when the geometric element is a three-dimensional shape, a second rule is determined by associating the creation method and creation rules of the coordinate system created based on the three-dimensional shape. In such cases, the storage device 240 stores a rule set including the first rule and the second rule in advance.

In addition, when the geometric element is a cylinder, a second rule for the cylinder may be determined in which a method of creating a coordinate system based on the cylinder and rules for creation are associated, or when the geometric element is a cone, a second rule for the cone may be determined in which a method of creating a coordinate system based on the cone and rules for creation are associated. In such cases, a rule set including the second rule for cylinders and the second rule for cones is stored in advance in the storage device 240.

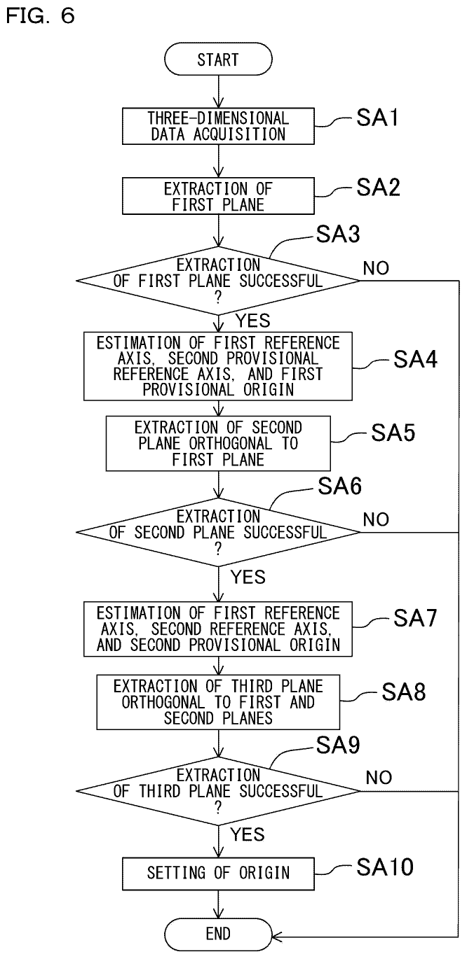

FIG. 6 is a flowchart showing the process of setting the reference coordinate system. This flowchart is started either when accepting an execution instruction from a user before analyzing the three-dimensional data of the workpiece W, or automatically without accepting an execution instruction, and it shows the case of using a plane for creating the coordinate system. Before this flowchart starts, the process of storing the rule set in the storage device 240 has been completed.

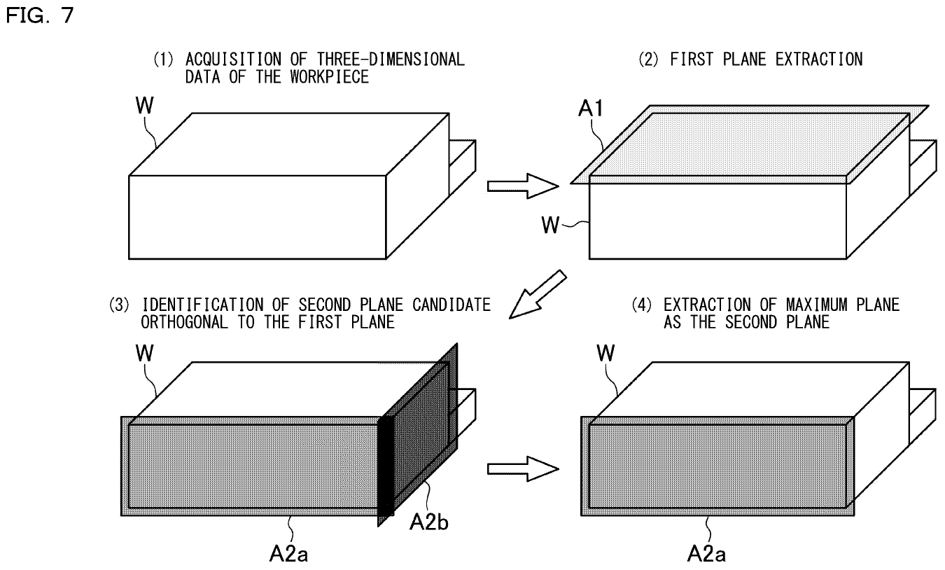

After the start, in step SA1, the data acquisition unit 291 acquires three-dimensional data of the workpiece W. FIG. 7 shows the three-dimensional data of the workpiece W acquired by the data acquisition unit 291, and this three-dimensional data may be mesh data or CAD data.

In step SA2, the extraction unit 292 extracts a geometric element (in this example, the first plane) from the three-dimensional data of the workpiece W acquired by the data acquisition unit 291. At this time, the extraction unit 292 can extract a plane using techniques such as RANSAC (Random sample consensus), and by using such techniques, it becomes possible to identify not only planes but also cylinders, spheres, cones, etc.

In step SA3, it is determined whether the extraction of the first plane in step SA2 was successful. The workpiece W may include multiple planes. In this case, the extraction unit 292 uses techniques such as RANSAC to identify multiple planes as candidates of the geometric elements from the three-dimensional data of the workpiece W. The extraction unit 292 calculates the size of each identified plane and extracts one plane from among the multiple identified planes based on the size of each plane. Specifically, the largest plane among the multiple identified planes is extracted, and as shown in (2) of FIG. 7, this largest plane is designated as the first plane A1. If the extraction of the first plane A1 is successful, YES is determined in step SA3 and the process proceeds to step SA4, whereas if the extraction of the first plane A1 fails, NO is determined in step SA3. If the extraction of the first plane A1 fails, the creation of reference axes based on geometric elements cannot be performed, so this flow is terminated.

When it is determined as YES in step SA3, the type identification unit 294 specifies the type of the geometric element extracted by the extraction unit 292. In this example, since the first plane A1 is extracted by the extraction unit 292, the type identification unit 294 specifies the type of the geometric element extracted by the extraction unit 292 as “plane”.

When the type identification unit 294 identifies the type of geometric element extracted by the extraction unit 292, the coordinate system setting unit 295 specifies one rule corresponding to the type of geometric element extracted by the extraction unit 292 from among the rule sets stored in the storage device 240, based on the type of geometric element identified by the type identification unit 294. In this example, since the geometric element extracted by the extraction unit 292 is a plane, the coordinate system setting unit 295 identifies and loads a rule (first rule) that is associated with methods and rules for creating a coordinate system based on a plane. The coordinate system setting unit 295 sets a reference coordinate system as explained in the following flow, based on the identified rule and the geometric element extracted by the extraction unit 292.

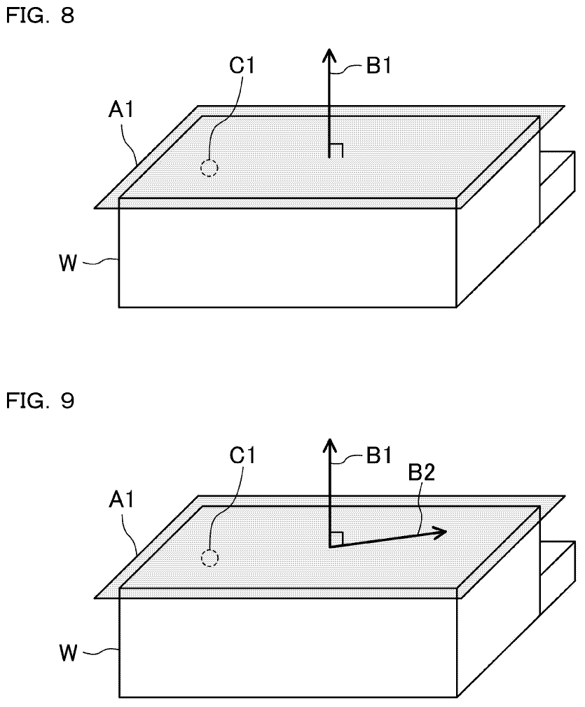

In step SA4, the coordinate system setting unit 295 estimates the first reference axis, the second provisional reference axis, and the provisional origin. Specifically, as shown in FIG. 8, the normal vector of the first plane A1 is set as the first reference axis B1, and the centroid of the point cloud constituting the first plane A1 is set as the first provisional origin C1. Also, as shown in FIG. 9, the first principal component (the direction in which the distribution of points is maximum) when performing principal component analysis on the point cloud constituting the first plane A1 is set as the second provisional reference axis B2. This allows reference axes to be set based on the maximum plane included in the three-dimensional data of the workpiece W, but since the second reference axis B2 is not set along any reference plane, it is insufficient for use in setting cross sections. Therefore, proceeding to step SA5, a second plane perpendicular to the first plane A1 is extracted. As shown in (3) of FIG. 7, since the extraction unit 292 uses the RANSAC method, multiple planes A2a, A2b can be specified as candidates for the second plane. Although not shown, there may be cases where three or more planes are specified.

In step SA6, it is determined whether the extraction of the second plane in step SA5 was successful. The RANSAC method is an algorithm that can identify multiple plane candidates and select the one that fits best among them; therefore, in cases where numerous planes are raised as candidates for the second plane, it is easy to narrow down to planes A2a and A2b by applying the constraint that it must be perpendicular to the first plane A1. As shown in (4) of FIG. 7, the extraction unit 292 extracts the larger plane A2a of the planes A2a and A2b that are perpendicular to the first plane A1 as the second plane. Note that if there are three or more planes perpendicular to the first plane A1, the largest plane is extracted as the second plane.

In the case where the extraction of the second plane A2a is successful, the process proceeds to step SA7 with YES being determined in step SA6, whereas in the case where the extraction of the second plane A2a fails, NO is determined in step SA6. In the case where the extraction of the second plane A2a fails, it is not possible to create a reference axis based on the geometric element, so this flow is terminated.

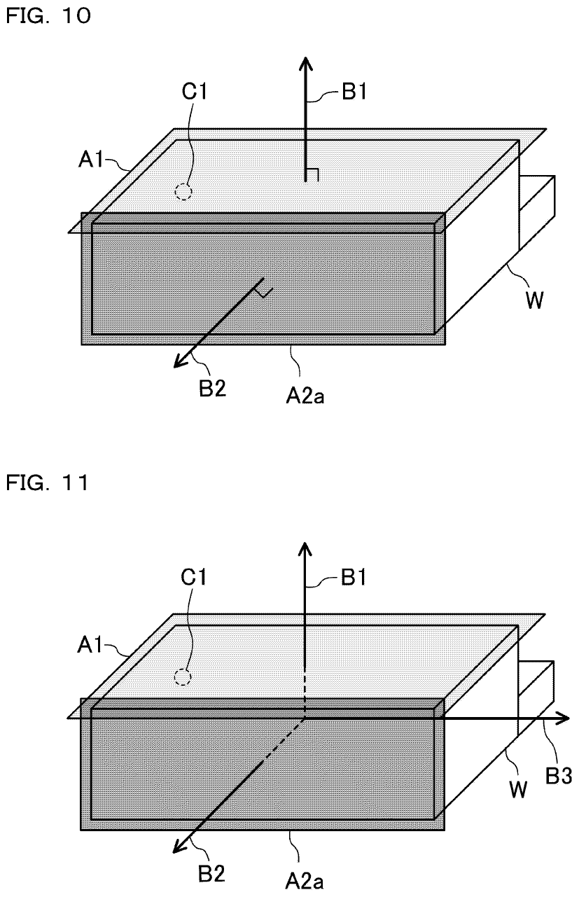

In step SA7, the coordinate system setting unit 295 estimates the first reference axis, the second reference axis, and the second provisional origin. Specifically, as shown in FIG. 10, the normal vector of the first plane A1 is set as the first reference axis B1, and the normal vector of the second plane A2a is set as the second reference axis B2. Once the first reference axis B1 and the second reference axis B2 are determined, the third reference axis B3 can be calculated by taking the cross product of the first reference axis B1 and the second reference axis B2 (as shown in FIG. 11). However, the first reference axis B1 and the second reference axis B2 may not be completely orthogonal to each other, and there may be some error in the angle between the first reference axis B1 and the second reference axis B2. To eliminate this error, the coordinate system setting unit 295 performs the following calculation.

(Third reference axis)=(First reference axis)×(Second reference axis)

(Second reference axis)=(Third reference axis)×(First reference axis)

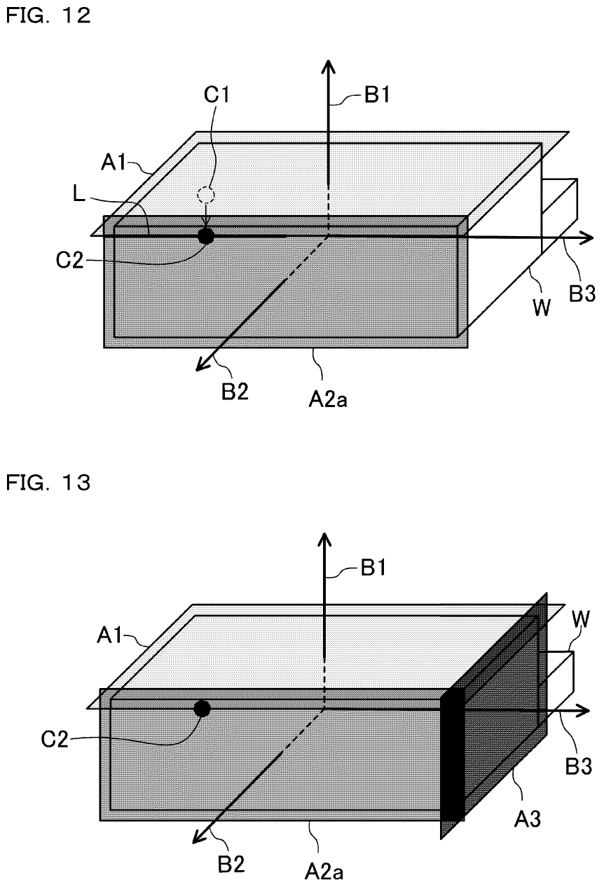

By having the coordinate system setting unit 295 perform this operation, the second reference axis B2 can be corrected to be orthogonal to the first reference axis B1 with high precision. Also, at this time, as shown in FIG. 12, the coordinate system setting unit 295 can project the first provisional origin C1 onto the intersection line L of the first plane A1 and the second plane A2a to create the second provisional origin C2.

In step SA8, the extraction unit 292 extracts a third plane A3 that is perpendicular to the first plane A1 and the second plane A2a, as shown in FIG. 13. In step SA9, it is determined whether the extraction of the third plane in step SA8 was successful. When there are numerous candidates for the third plane, the third plane A3 can be easily narrowed down by imposing the restriction that it must be perpendicular to the first plane A1 and the second plane A2a.

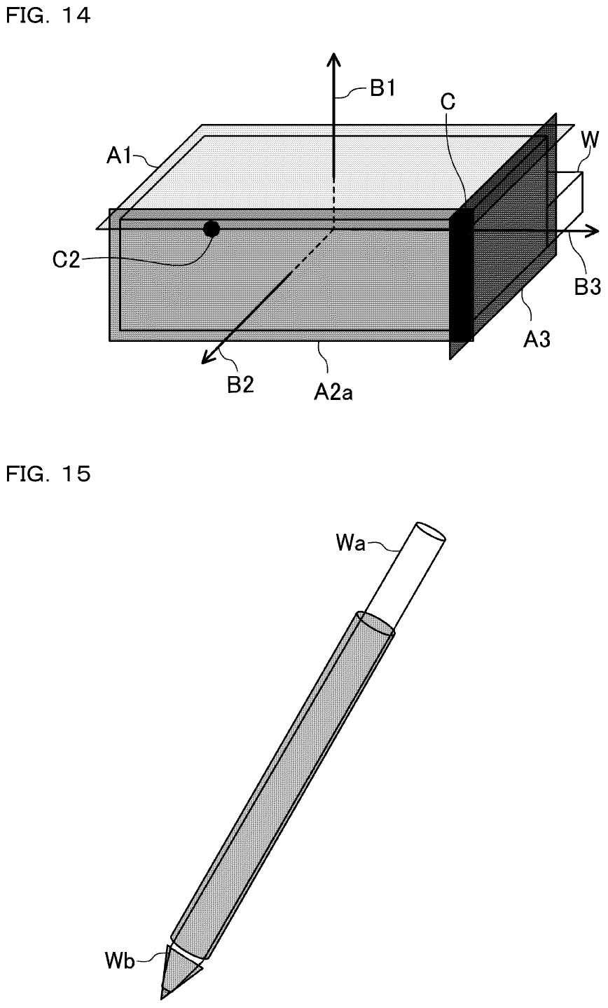

In step SA10, the coordinate system setting unit 295 sets an origin. As shown in FIG. 14, the coordinate system setting unit 295 calculates a point where the first plane A1, the second plane A2a, and the third plane A3 intersect, and sets the point where the first plane A1, the second plane A2a, and the third plane A3 intersect as the origin C of the reference coordinate system. That is, the coordinate system setting unit 295 estimates the first reference axis B1, the second reference axis B2, and the third reference axis B3 based on the rule stored in the storage device 240 and the planes extracted by the extraction unit 292, and sets the reference coordinate system from the estimated first reference axis B1, second reference axis B2, and third reference axis B3. Note that if extraction of each plane fails, the provisional origin and provisional reference axes can be set as the final estimation result for the reference coordinate system.

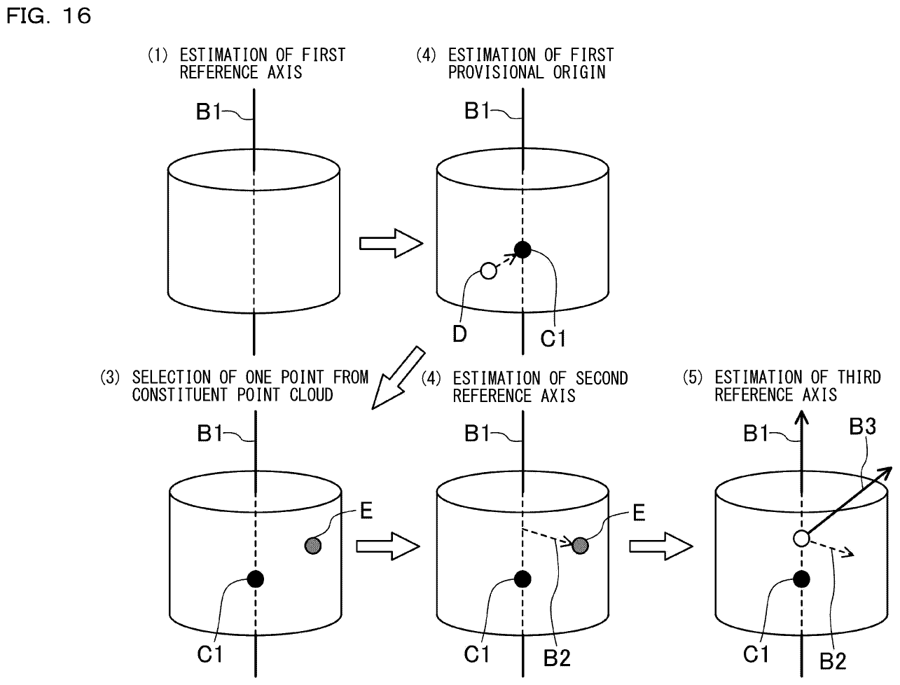

The above example is an example where the extraction unit 292 extracts a plane as a geometric element from three-dimensional data, but the geometric element extracted from three-dimensional data is not limited to a plane and may be a three-dimensional shape. For example, in the case where a pin as shown in FIG. 15 is the workpiece W to be measured, the pin includes a cylinder part Wa and a cone part Wb as three-dimensional shapes. In this case, the extraction unit 292 extracts the cylinder part Wa and the cone part Wb as geometric elements from the three-dimensional data. It should be noted that only one of the cylinder part Wa and the cone part Wb may be extracted. In FIG. 16, a case where the extraction unit 292 extracts the cylinder part Wa is described, but the same applies to the case where the cone part Wb is extracted.

The coordinate system setting unit 295 estimates the first reference axis B1 as shown in (1) of FIG. 16. Specifically, the coordinate system setting unit 295 first calculates the axis of the cylindrical part Wa. The coordinate system setting unit 295 sets the calculated axis of the cylindrical part Wa as the first reference axis B1. Similarly, when the conical part Wb is extracted, the coordinate system setting unit 295 calculates the axis of the conical part Wb and sets the calculated axis of the conical part Wb as the first reference axis B1.

Thereafter, as shown in FIG. 16 (2), the coordinate system setting unit 295 calculates a centroid D of the point cloud constituting the cylinder part Wa. The coordinate system setting unit 295 sets a first provisional origin C1 as a projection of the centroid D onto the first reference axis B1. At this time, since the centroid D is the centroid of the point cloud constituting the cylinder part Wa, it does not necessarily coincide with the centroid of the extracted cylinder part Wa. Similarly, when the cone part Wb is extracted, the coordinate system setting unit 295 calculates the centroid D of the point cloud constituting the cone part Wb, and sets the first provisional origin C1 as a projection of the centroid D onto the first reference axis B1.

Next, the coordinate system setting unit 295 selects a point E from the point cloud constituting the cylindrical portion Wa, as shown in (3) of FIG. 16. After selecting point E, as shown in (4), a line that passes through the point E selected in (3) and the first reference axis B1, and is perpendicular to the first reference axis B1, is designated as the second reference axis B2. In this way, since the cylindrical portion Wa has an axisymmetric shape, it is difficult to uniquely determine the second provisional reference axis, so a single point is selected from the point cloud constituting the cylindrical portion Wa, and a perpendicular line passing through that point and the first reference axis B1 is used as the second provisional reference axis. The second reference axis B2 can be determined in the same way for the conical portion Wb.

As shown in (5) of FIG. 16, the coordinate system setting unit can determine the third reference axis B3 by taking the cross product of the first reference axis B1 and the second reference axis B2. Similarly, the third reference axis B3 can be determined for the cone part Wb as well.

The analysis unit 296 is a part that performs analysis of the three-dimensional data of the workpiece W based on the reference coordinate system set by the coordinate system setting unit 295. For example, the analysis unit 296 can perform dimension analysis of a cross section of the three-dimensional data of the workpiece W where the cross section intersects with the first reference axis set by the coordinate system setting unit 295, or perform dimension analysis of a cross section of the three-dimensional data of the workpiece W where the cross section intersects with the second reference axis, or perform dimension analysis of a cross section of the three-dimensional data of the workpiece W where the cross section intersects with the third reference axis, and so on.

Furthermore, the analysis unit 296 can determine the position of the cross section based on the centroid of the workpiece W. Additionally, the analysis unit 296 can accept adjustment of the position of the cross section by the user. For example, the user can perform adjustment operation of the position of the cross section by operating the operation unit 250, and the analysis unit 296 adjusts the position of the cross section according to the operation by detecting the operation state of the operation unit 250 by the user. This enables analysis using a cross section at a position desired by the user.

The analysis unit 296 can also project the three-dimensional data of the workpiece W onto the reference planes defined by a plurality of reference axes set by the coordinate system setting unit 295, and perform dimension analysis of the projected three-dimensional data obtained by said projection. For example, it can analyze dimensions such as the width of the projected shape and the angle between two edges of the projected shape.

### (Form Using Symmetry Plane as Reference Plane)

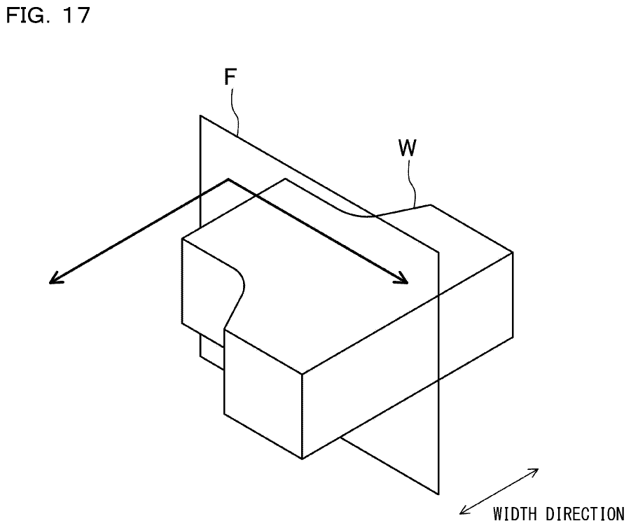

Many industrial products have symmetric shapes. For example, the workpiece W shown in FIG. 17 is a product that has a symmetry plane F which passes through the central part in the width direction and extends in the up-down direction. For a workpiece W having a symmetry plane F, the symmetry plane F may be used as a reference plane. That is, the symmetry determination unit 293 shown in FIG. 5 is a part that determines the symmetry of the three-dimensional data of the workpiece W acquired by the data acquisition unit 291. When the three-dimensional data of the workpiece W is acquired by the data acquisition unit 291, the symmetry determination unit 293 determines whether or not the three-dimensional data of the workpiece W has symmetry. When the symmetry determination unit 293 determines that there is symmetry, it specifies the symmetry plane F.

Moreover, for example, the workpiece W shown in FIG. 15 is also a workpiece with symmetry. In the case of the workpiece W shown in FIG. 15, a plane passing through the axis of the cylindrical part Wa and the conical part Wb and extending in the radial direction becomes a symmetry plane. Although such planes exist in infinite numbers in the workpiece W shown in FIG. 15, the symmetry determination unit 293 specifies any one of these planes as a symmetry plane.

The detection method for symmetry planes is not particularly limited, and for example, 3DSymm: Robust and Accurate 3D Reflection Symmetry Detection or the like can be used. Also, in the method for detecting symmetry planes, by replacing the method of determining the reference plane with plane fitting, the reference axis estimation flow (shown in FIG. 6) can be applied almost as is. When setting the second provisional reference axis, etc., instead of using points that constitute a plane, it is sufficient to use all points projected onto the symmetry reference plane.

When the symmetry determination unit 293 determines that the three-dimensional data has symmetry, the extraction unit 292 extracts the symmetry plane as a reference plane. The coordinate system setting unit 295 sets a reference axis based on the symmetry plane extracted as the reference plane. By utilizing the symmetry plane F, it becomes possible to appropriately set a reference plane even when there is no clear plane or cylinder in the three-dimensional data.

### (Creation of Reference Coordinate System by Combination of Plane, Three-Dimensional Shape, and Symmetry Plane)

As described above, in this embodiment, a reference coordinate system can be automatically created using each of a plane, cylinder, cone, and symmetry plane contained in the three-dimensional data of the workpiece W, but this is not limited thereto, and a reference coordinate system can also be automatically created by combining and using any two or more of a plane, cylinder, cone, and symmetry plane. For example, a combination of a cylinder and a plane, a combination of a symmetry plane and a plane, and so on. It is also possible to simultaneously detect these multiple geometric elements and select the one that fits the largest number of points to determine the reference axis.

On the other hand, it is also possible to accept the designation of planes and the like from the user, limit to the planes and the like designated by the user, and perform processing such that the first reference axis is specified using a plane, and the second reference axis is specified using a cylinder.

As a method for easily realizing such a combination of multiple geometric elements, a method of creating a rule set such as a table or tree showing multiple rules and storing this rule set in advance in the storage device 240 can be mentioned. For example, when two types of rules are set: one where the geometric element is a plane or symmetry plane (where the determining element of the reference axis is a plane), and another where the geometric element is a cylinder or cone (where the determining element of the reference axis is an axis), to estimate the first reference axis, second reference axis, and third reference axis, a table is constructed by the rule applied to estimate the first reference axis (1st rule), the rule applied to estimate the second reference axis (2nd rule), and the rule applied to estimate the third reference axis (3rd rule).

Specifically, showing examples of combinations in the order of the first rule-second rule-third rule, a total of 8 tables are created in advance: plane-plane-plane, plane-plane-axis, plane-axis-plane, plane-axis-axis, axis-plane-plane, axis-axis-plane, axis-plane-axis, and axis-axis-axis. “Plane” refers to rules for geometric elements that are planes or symmetry planes, and “axis” refers to rules for geometric elements that are cylinders or cones. By creating such rule sets in advance, reference axes and origins can be easily determined corresponding to the geometric elements extracted by the extraction unit 292.

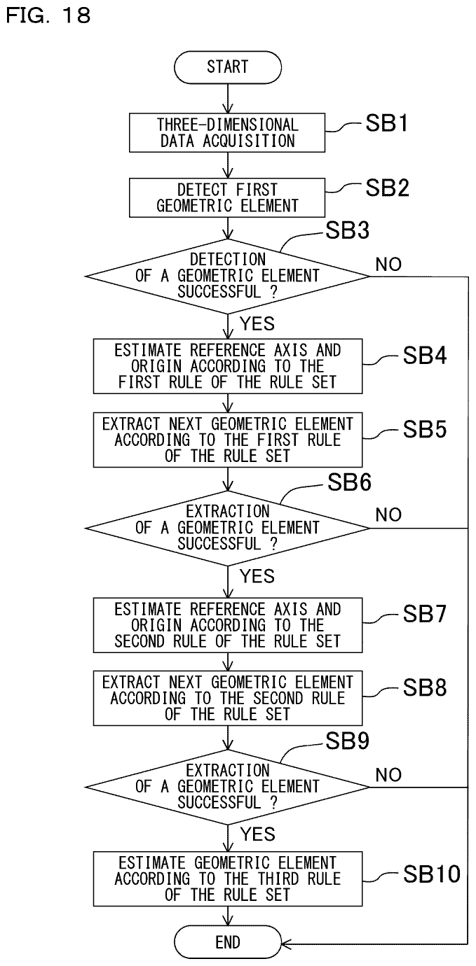

FIG. 18 is a flowchart for setting a reference coordinate system based on a plurality of types of geometric elements. After the start, in step SB1, the data acquisition unit 291 acquires three-dimensional data of the workpiece W. In step SB2, the extraction unit 292 extracts geometric elements from the three-dimensional data of the workpiece W acquired by the data acquisition unit 291.

In step SB3, it is determined whether the extraction of the geometric element in step SB2 was successful or not. If the extraction of the geometric element fails, NO is determined in step SB3. If the extraction of the geometric element fails, a reference axis cannot be created based on the geometric element, so this flow is terminated.

In step SB2, when a geometric element such as a plane, cylinder, cone, or symmetry plane is extracted, the extraction unit 292 determines YES in step SB3. In step SB4, the type identification unit 294 determines whether the extracted geometric element is a plane or symmetry plane, or a cylinder or cone. Then, the coordinate system setting unit 295 determines which rule in the rule set to apply as the first rule to estimate the reference axis. When the extracted geometric element is a plane or symmetry plane, the “plane” rule is applied as the first rule, and when the extracted geometric element is a cylinder or cone, the “axis” rule is applied as the first rule. After determining the rule to apply, the coordinate system setting unit 295 estimates the first reference axis and provisional origin according to the determined rule.

In step SB5, the extraction unit 292 extracts the next geometric element (second geometric element) from the three-dimensional data of the workpiece W according to the first rule applied in step SB4. In step SB5, when a geometric element such as a plane, cylinder, cone, or symmetry plane is extracted, the extraction unit 292 determines YES in step SB6. In step SB7, the type identification unit 294 determines whether the extracted geometric element is a plane or symmetry plane, or a cylinder or cone. Then, the coordinate system setting unit 295 determines which rule in the table should be applied as the second rule to estimate the reference axis. When the extracted geometric element is a plane or symmetry plane, the “plane” rule is applied as the second rule, and when the extracted geometric element is a cylinder or cone, the “axis” rule is applied as the second rule. After determining the rule to be applied, the coordinate system setting unit 295 estimates the second reference axis and provisional origin according to the determined rule.

In step SB8, the extraction unit 292 extracts the next geometric element (third geometric element) from the three-dimensional data of the workpiece W according to the second rule applied in step SB7. In step SB8, if a geometric element such as a plane, cylinder, cone, or symmetry plane is extracted, the extraction unit 292 determines YES in step SB9. In step SB9, the type identification unit 294 determines whether the extracted geometric element is a plane or symmetry plane, or a cylinder or cone. Then, the coordinate system setting unit 295 determines which rule in the table should be applied as the third rule to estimate the reference axis. If the extracted geometric element is a plane or symmetry plane, the “plane” rule is applied as the third rule, and if the extracted geometric element is a cylinder or cone, the “axis” rule is applied as the third rule. After determining the rule to be applied, the coordinate system setting unit 295 estimates the third reference axis and origin according to the determined rule, and sets the reference coordinate system.

As described above, when the extraction unit 292 extracts geometric elements from three-dimensional data of the workpiece W, it is possible to extract a plurality of reference plane candidates. Also, when the extraction unit 292 extracts geometric elements from three-dimensional data of the workpiece W, it is also possible to extract a plurality of three-dimensional shape candidates. When the extraction unit 292 extracts a plurality of reference plane candidates and a plurality of three-dimensional shape candidates, it calculates the degree of match between the point clouds constituting each reference plane candidate and the reference plane candidate, and the degree of match between the point clouds constituting each three-dimensional shape candidate and the three-dimensional shape candidate, respectively. The extraction unit 292 is capable of extracting geometric elements to be used for creating a coordinate system from among the plurality of extracted reference plane candidates and the plurality of three-dimensional shape candidates, based on the degree of match between the point clouds constituting each reference plane candidate and the reference plane candidate, and the degree of match between the point clouds constituting each three-dimensional shape candidate and the three-dimensional shape candidate.

### (Measurement Item Suggestion Function)

The three-dimensional scanner 1 of this embodiment, though not essential, has a measurement item suggestion function. While the three-dimensional scanner 1 can acquire three-dimensional data of a workpiece W, there are many types of three-dimensional measurement items, for example, cross section measurement, three-dimensional measurement, plane measurement, thickness measurement, geometric tolerance, etc. With such a variety of measurement items, users who are not familiar with the system often do not know which measurement item to use. On the other hand, experienced users generally understand which measurement items are commonly used when they see a workpiece W. The measurement item suggestion function assists inexperienced users in their measurement work by suggesting options similar to those that experienced users would select. The measurement items are also called analysis menus.

There are several techniques to realize the function of proposing measurement items, but two main techniques will be explained below.

Method 1 involves creating pairs of acquired three-dimensional data and recommendation scores for each measurement item to be performed on the acquired three-dimensional data as learning and test data, and constructing either a rule-based algorithm or a machine learning model trained on the learning data.

Method 2 is a method for creating data that links the acquired three-dimensional data with the type of product of the workpiece W included in the acquired three-dimensional data (whether it is sheet metal, machined part, etc.), classifying them using an algorithm similar to Method 1 (rule based or machine learning model), and calculating the recommendation score of measurement items from that product type.

The difference between method 1 and method 2 is the difference in labels assigned to the training data. Method 1 is the recommendation score for each measurement item set by an expert, and method 2 is the type of product as an industrial product. The type of product in method 2 is relatively easy to determine, so the cost of constructing training data for method 2 is lower. On the other hand, the correspondence relationship between product type and measurement item is fixed, and if the probability of belonging to the same item is constant, the recommendation score for the measurement item is also fixed. For example, if the probability of being sheet metal is constant, the recommendation score for thickness measurement will not change regardless of what kind of sheet metal it is.

Next, a method of classification will be described. When three-dimensional data is acquired, feature vectors are first calculated. These include those based on machine learning such as PointNet, those determined by rule-based methods like VFH (Viewpoint Feature Histogram), and those that arrange physical quantities understandable to humans such as volume and surface area. Of course, these can be combined.

These feature quantities are used as input to create a classifier using rule-based or machine learning algorithms. If the feature quantities are arranged as physical quantities that humans can understand, such as volume and surface area, classification rules can be determined by heuristics, for example, if the volume/surface area value is small, the object is thin; if only the first principal component is large when performing principal component analysis, the object is rod-shaped; if up to the second principal component is large, the object is plate-shaped; and if up to the third principal component is large, the object has a complex shape. These methods are effective when only a small amount of data can be collected because they do not require training data.

When a certain amount of training data is collected, machine learning can be used. Representative classifiers that can be used include, for example, SVM (Support Vector Machine), Random Forest, DNN (Deep Neural Network), etc. The output of these classifiers is the probability of belonging to a classification result (for example, the probability of being sheet metal is 0.6, the probability of being a flat plate is 0.4, etc.). In the case of the previously mentioned Method 1, since the probability of an experienced person selecting that measurement item is directly output, the output can be used as a recommendation score as is.

On the other hand, in the case of Method 2, the output of the classifier is the probability of belonging to each type of object, so it cannot be used directly as a score for measurement items. For example, in the case where thickness is measured if the object is pressed sheet metal or a flat plate, with the membership probabilities of the classifier denoted as P (pressed) and P (flat plate), the probability can be calculated as:

$$P ( thickness measurement ) = max [ P ( pressed ) , P ( flat plate ) ] .$$

For objects other than cylindrical shape and that are block-shaped, when proposing cross section measurement,

$$P ( cross section measurement ) = min [ 1 - P ( cylinder ) , P ( block ) ] can be calculated .$$

In this way, logical operations can be realized by replacing AND with min operation, NOT with the difference from 1, and OR with max operation. Of course, this can also be realized by using multiplication for AND, addition for OR, and the difference from 1 for NOT, and clipping the result within the range of 0 to 1.

After calculating the recommendation score in this manner, the items are arranged in descending order of recommendation score, and when an item is selected, an explanation of that measurement item is displayed. This allows the user to select measurement items that are likely to be used simply by looking at each item from the top down. Additionally, a certain number of items from the top, or items with recommendation scores above a certain value, can be automatically measured, allowing users to select the measurement items they want to perform while viewing the results with their own three-dimensional data. In this case, it is preferable to set the reference coordinate system using the coordinate system setting unit 295 as described above, as automatic determination of the reference axis is necessary. Furthermore, since executing multiple measurements takes calculation time, measurements can also be automatically executed and the results displayed using pre-thinned preview three-dimensional data.

The model is a model for specifying a combination of analysis menus to be used for analyzing three-dimensional data from among a plurality of analysis menus prepared in advance, based on the shape of the three-dimensional data of the workpiece W. This model is stored in the storage device 240 shown in FIG. 2, and includes rule-based classification tools such as classification lists and correspondence tables, as well as machine learning-based classification tools. For example, a classification list showing classification targets for classifying three-dimensional data based on shape, and a correspondence table in which analysis menus to be used for analyzing three-dimensional data are associated with each classification target included in the classification list, can be stored in the storage device 240.

The analysis module 290 includes a model creation unit 298. The model creation unit 298 is a part that accepts input of multiple sets of training three-dimensional data and teacher data that associates type of product/shape classification with each training three-dimensional data, and creates a model that classifies the type of product/shape based on the input teacher data. When this model creation unit 298 creates a model, the storage device 240 can store the model created by the model creation unit 298 and a correspondence table in which the type of product/shape and analysis menu are associated with each other.

Further, the model creation unit 298 can accept input of multiple learning three-dimensional data and training data that associates analysis menus with each learning three-dimensional data, and based on the input training data, create a model for estimating an analysis menu to be used for analyzing three-dimensional data of the workpiece W from multiple pre-prepared analysis menus. In this case, the storage device 240 can store a model for estimating an analysis menu to be used for analyzing three-dimensional data of the workpiece W from multiple pre-prepared analysis menus.

As shown in FIG. 5, the analysis module 290 has a candidate identification unit 297. The candidate identification unit 297 acquires the shape of the three-dimensional data obtained by the data acquisition unit 291 and the model stored in the storage device 240. Based on the shape of the three-dimensional data obtained by the data acquisition unit 291 and the model stored in the storage device 240, the candidate identification unit 297 identifies combination candidates of analysis menus to be used for analysis of the three-dimensional data from multiple analysis menus prepared in advance. When a classification list is stored in the storage device 240, the candidate identification unit 297 can calculate a degree of similarity for each classification target included in the classification list stored in the storage device 240 for the three-dimensional data obtained by the data acquisition unit 291. Then, the candidate identification unit 297 calculates a recommendation score for each of the multiple analysis menus based on the calculated degree of similarity for the classification targets and the correspondence table stored in the storage device 240. The candidate identification unit 297 can also identify the analysis menu to be used for analysis from the analysis menus based on the recommendation score. For example, analysis menus with recommendation scores above a predetermined level or analysis menus with the highest recommendation scores are proposed to the user as analysis menus to be used for analysis.

In addition, when a model is created in the model creation unit 298, the candidate identification unit 297 can classify the type of product/shape based on the three-dimensional data acquired by the data acquisition unit 291 and the model created by the model creation unit 298 and stored in the storage device 240, and can specify the analysis menu to be used for the analysis of the three-dimensional data based on the classified type of product/shape and the correspondence table stored in the storage device 240.

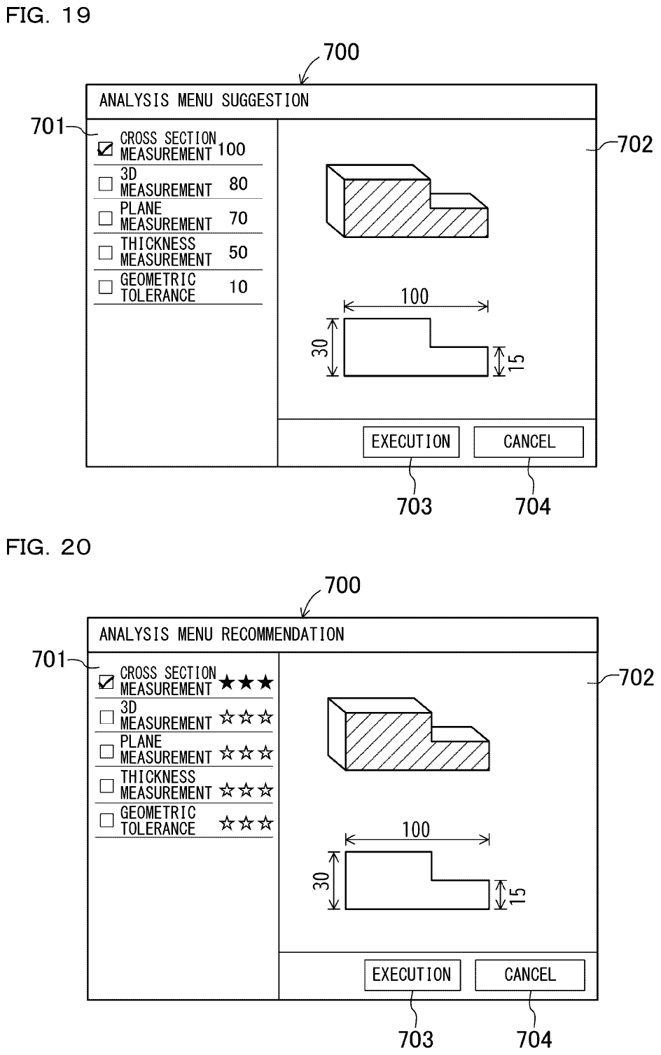

The display control unit 255 shown in FIG. 2 is a part that causes the display unit 400 to display the combination of analysis menus specified by the candidate identification unit 297. FIGS. 19 and 20 show a proposal screen 700 that the display control unit 255 causes the display unit 400 to display. The proposal screen 700 is provided with an analysis menu display region 701, a measurement result display region 702, an execution button 703 operated when executing measurement, and a cancel button 704 operated when canceling measurement.

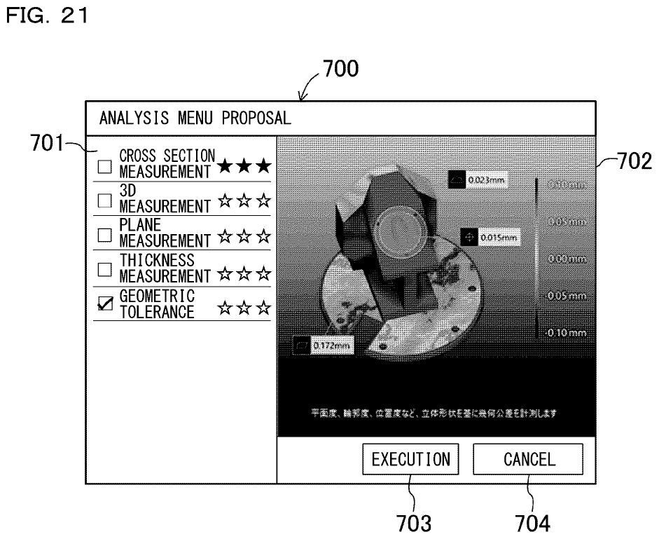

In the analysis menu display area 701, a combination of analysis menus identified by the candidate identification unit 297 is displayed in a list format. In the analysis menu display area 701, the recommendation score of each analysis menu is displayed as a numerical value (FIG. 19) or a figure (FIG. 20), with higher values indicating higher recommendation scores. That is, the analysis menu display area 701 displays multiple analysis menus and information indicating the recommendation score for each analysis menu. Also, an illustrative drawing or preview screen 705 corresponding to each analysis menu may be displayed on the proposal screen 700. The illustrative drawing or preview screen 705 may be switched to an illustrative drawing or preview screen corresponding to the analysis menu indicated by the cursor based on the position of the cursor (see FIG. 21). FIG. 21 shows a case where the cursor position is on the geometric tolerance menu, and an illustrative drawing corresponding to the geometric tolerance menu is displayed on the screen.

Furthermore, checkboxes are also provided corresponding to each analysis menu, allowing the user to select which analysis menu to execute the measurement from the combination of analysis menus. In other words, the analysis unit 296 is configured to accept analysis menu selection operations from the user.

When the execution button 703 is operated, measurement is executed with the selected analysis menu, and the measurement result is displayed in the measurement result display region 702. On the other hand, when the cancel button 704 is operated, the measurement is canceled without being executed.

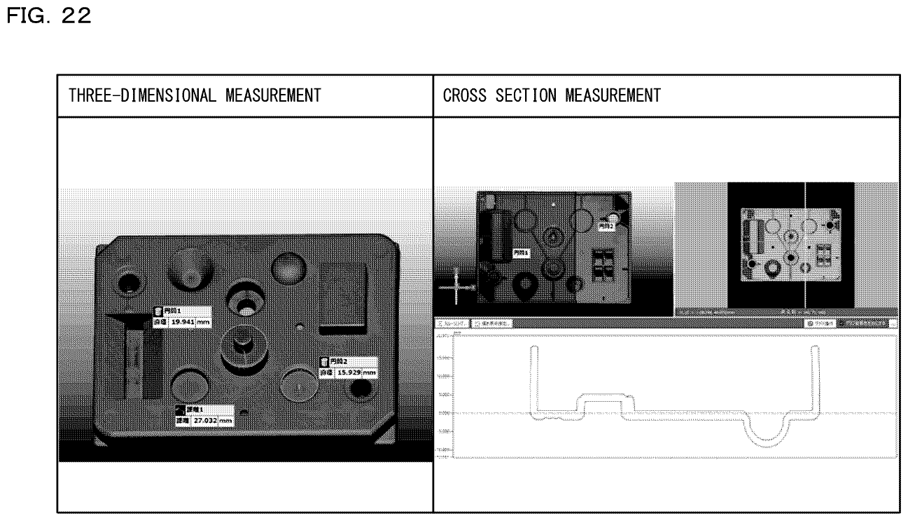

Here, when the execution button 703 is operated while multiple analysis menus are selected, measurements based on each selected analysis menu are executed, and multiple measurement results corresponding to each analysis menu are displayed. The multiple measurement results may be displayed in tab format, or they may be displayed in different windows, or multiple measurement results may be arranged side by side in a single result screen. FIG. 22 shows a case where cross section measurement and three-dimensional measurement have been selected as analysis menus, and measurement has been executed by the analysis unit 296. In this way, a first measurement result screen and a second measurement result screen may be displayed respectively. For example, the first measurement result screen may show the three-dimensional measurement results, and the second measurement result screen may show the cross section measurement results.

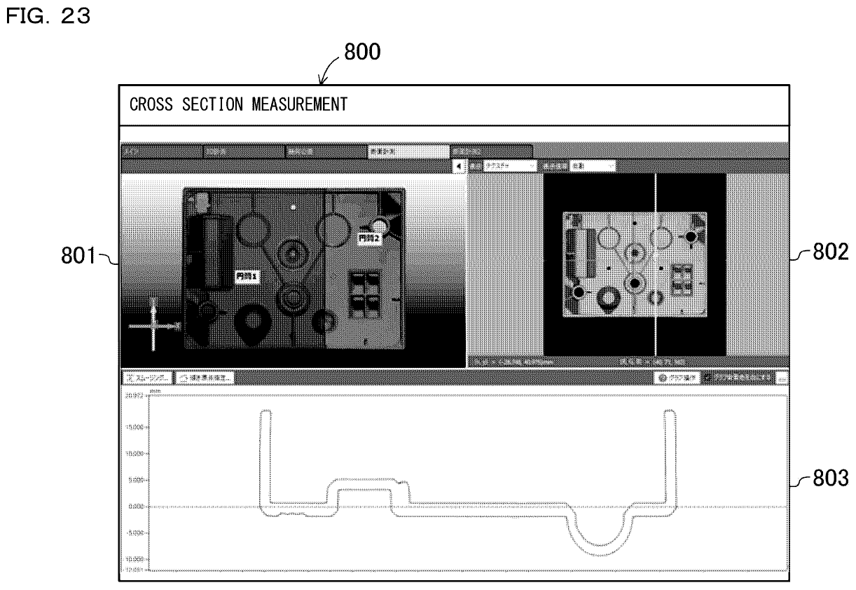

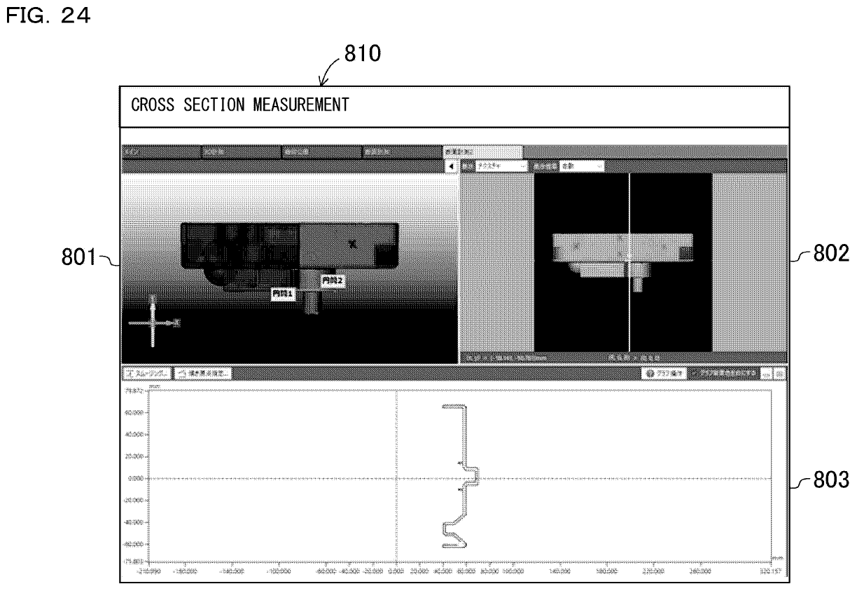

In the cross section measurement result screen 800 shown in FIG. 23, three-dimensional data may be displayed in the first result display region 801 based on the coordinate system set by the coordinate system setting unit 295. In the first result display region 801, the three-dimensional data may be displayed in a three-dimensional space. Also, the three-dimensional data may be displayed in the second result display region 802 based on the coordinate system set by the coordinate system setting unit 295. In the second result display region 802, the three-dimensional data may be displayed as a two-dimensional image viewed from a predetermined direction. Furthermore, as shown in FIG. 24, the analysis unit 296 may cut the three-dimensional data with a plane intersecting the first axis of the coordinate system set by the coordinate system setting unit 295, and the cross-sectional shape obtained by cutting the three-dimensional data may be displayed in the third result display region 803. Also, when cross section measurement is selected as the analysis menu and measurement is executed by the analysis unit 296, a second result screen 810 for cross section measurement may be displayed in addition to the cross section measurement result screen 800. The second result screen 810 for cross section measurement may include the first result display region 801, the second result display region 802, and the third result display region 803, similar to the cross section measurement result screen 800. Note that in the third result display region 803, the analysis unit 296 may cut the three-dimensional data with a plane intersecting the second axis of the coordinate system set by the coordinate system setting unit 295, and the cross-sectional shape obtained by cutting the three-dimensional data may be displayed.

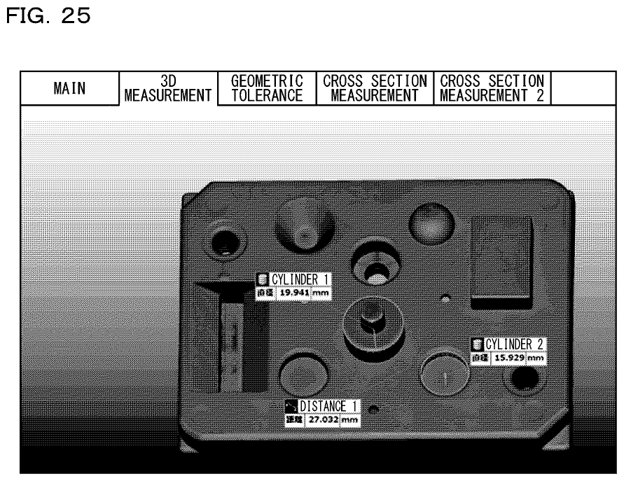

In the result screen of three-dimensional measurement shown in FIG. 25, three-dimensional data is displayed based on the coordinate system set by the coordinate system setting unit 295. In addition, analysis results by the analysis unit 296, such as dimensions of geometric elements extracted by the extraction unit 292 and distances between geometric elements, may be displayed superimposed on the three-dimensional data.

Moreover, the analysis module 290 is provided with a preliminary analysis unit 299 (shown in FIG. 5) that reduces the resolution of the three-dimensional data acquired by the data acquisition unit 291, and executes a preliminary analysis based on the combination of the low-resolution three-dimensional data and the analysis menu specified by the candidate identification unit 297. In this case, the display control unit 255 can display the preliminary analysis results from the preliminary analysis unit 299 in preview format on the display unit 400 or in the measurement result display region 702.

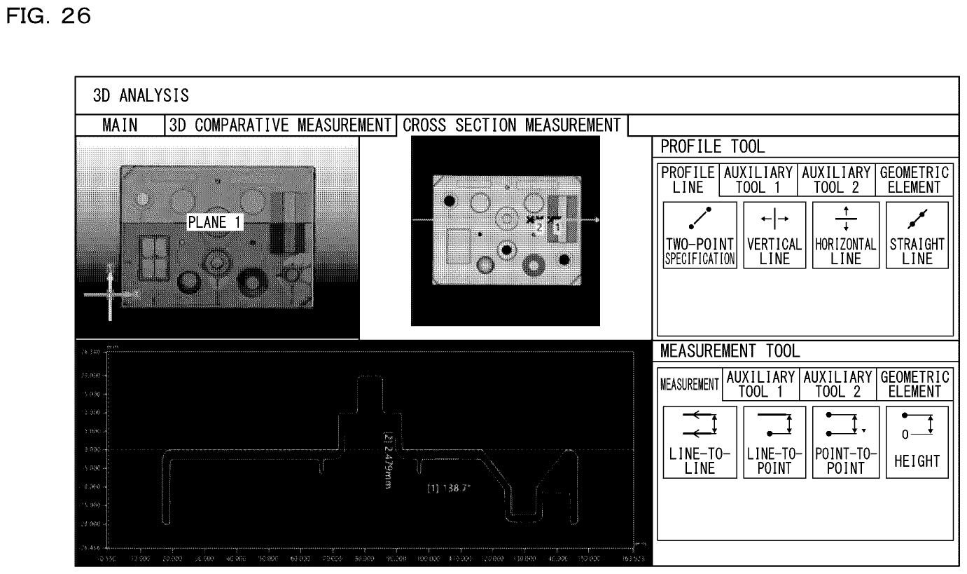

Furthermore, the analysis module 290 can read CAD data stored in the storage device 240 as a reference model, and the analysis unit 296 can execute analysis and perform comparison with the three-dimensional data of the workpiece W. FIG. 26 is a diagram showing an example of executing cross section measurement on CAD data. For the CAD data, a reference coordinate system is set through the extraction unit 292, type identification unit 294, and coordinate system setting unit 295, similar to the flow shown in FIG. 6. The analysis unit 296 can perform dimensional analysis of a cross section by setting a plane intersecting with the first reference axis set by the coordinate system setting unit 295 as the cutting plane of the CAD data, or perform dimensional analysis of a cross section by setting a plane intersecting with the second reference axis as the cutting plane of the CAD data, or perform dimensional analysis of a cross section by setting a plane intersecting with the third reference axis as the cutting plane of the CAD data, etc. FIG. 23 is a diagram showing an example of executing cross section measurement on the three-dimensional data of the workpiece W. By comparing the results of the cross section measurements of the CAD data and the three-dimensional data of the workpiece W, the design values of the CAD data and the measured values of the workpiece W can be compared. The analysis module 290 may automatically execute the above comparison based on receiving instructions to read the CAD model, and the display control unit 255 may display the comparison results on the display unit 400, or the analysis module 290 may automatically execute the above comparison based on receiving instructions to start the comparison, and the display control unit 255 may display the comparison results on the display unit 400.

Furthermore, the analysis unit 296 can align the read CAD data and the three-dimensional data of the workpiece W based on shape and coordinate system information. For the data in which the three-dimensional data of the workpiece W and the CAD data are aligned, a reference coordinate system is set by the extraction unit 292, type identification unit 294, and coordinate system setting unit 295, similar to the flow shown in FIG. 6. The analysis unit 296 can perform dimension analysis by setting a plane intersecting the first reference axis set by the coordinate system setting unit 295 as the cross section of the data in which the three-dimensional data of the workpiece W and the CAD data are aligned, or by setting a plane intersecting the second reference axis as the cross section of the data in which the three-dimensional data of the workpiece W and the CAD data are aligned and performing dimension analysis on that cross section, or by setting a plane intersecting the third reference axis as the cross section of the data in which the three-dimensional data of the workpiece W and the CAD data are aligned and performing dimension analysis on that cross section. Based on the results of the cross section measurement of the aligned CAD data and the three-dimensional data of the workpiece W, the design value of the CAD data and the measured value of the workpiece W can be compared. The analysis module 290 may automatically execute the above comparison based on receiving instructions to read the CAD model, and the display control unit 255 may cause the display unit 400 to display the comparison results, or the analysis module 290 may automatically execute the above comparison based on receiving instructions to start the comparison, and the display control unit 255 may cause the display unit 400 to display the comparison results.

The above-described embodiment is merely exemplary in all aspects and should not be interpreted in a limiting manner. Furthermore, all modifications and changes belonging to the equivalent scope of the claims are within the scope of the present invention.

As described above, the present disclosure can be used when analyzing three-dimensional data of a workpiece.

What is claimed is:

1. An information processing apparatus for analyzing three-dimensional data of a workpiece with a predetermined coordinate system set, the apparatus comprising:
a storage unit that stores in advance a rule set associating a plurality of types of geometric elements used for creating a coordinate system with information for creating a coordinate system based on each type of geometric element;
a data acquisition unit that acquires the three-dimensional data of the workpiece;
an extraction unit that extracts geometric elements from the three-dimensional data of the workpiece acquired by the data acquisition unit;
a type identification unit that identifies the type of the geometric elements extracted by the extraction unit;
a coordinate system setting unit that identifies one rule from the rule set stored in the storage unit based on the type of the geometric elements identified by the type identification unit, and sets a reference coordinate system based on the identified one rule and the geometric elements extracted by the extraction unit; and
an analysis unit that performs analysis of the three-dimensional data of the workpiece based on the reference coordinate system set by the coordinate system setting unit.

2. The information processing apparatus according to claim 1, wherein
the storage unit stores a rule that associates a plane as the type of the geometric element with information for creating a coordinate system based on the plane,
the extraction unit extracts one plane as the geometric element from the three-dimensional data,
the coordinate system setting unit estimates a reference axis based on the rule and the plane extracted by the extraction unit, and sets the reference coordinate system based on the estimated reference axis.

3. The information processing apparatus according to claim 2, wherein
the extraction unit specifies a plurality of planes as candidates of the geometric elements and extracts one plane from among the specified plurality of planes based on the size of each plane.

4. The information processing apparatus according to claim 2, wherein
the storage unit stores a rule that associates a three-dimensional shape as the type of the geometric element with information for creating a coordinate system based on the three-dimensional shape,
the extraction unit extracts one three-dimensional shape as the geometric element from the three-dimensional data,
the coordinate system setting unit estimates a reference axis based on the rule and the three-dimensional shape extracted by the extraction unit, and sets the reference coordinate system based on the estimated reference axis.

5. The information processing apparatus according to claim 1, further comprising a symmetry determination unit that determines symmetry of the three-dimensional data of the workpiece acquired by the data acquisition unit,
wherein the extraction unit extracts a symmetry plane as a reference plane when the symmetry determination unit determines that the three-dimensional data has symmetry, and
wherein the coordinate system setting unit sets a reference axis based on the symmetry plane extracted as the reference plane.

6. The information processing apparatus according to claim 1, wherein
the extraction unit extracts a plurality of reference plane candidates and a plurality of three-dimensional shape candidates, and extracts the geometric elements from among the extracted plurality of reference plane candidates and the plurality of three-dimensional shape candidates based on a degree of match between point clouds constituting each reference plane candidate and the reference plane candidate, and a degree of match between point clouds constituting each three-dimensional shape candidate and the three-dimensional shape candidate.

7. The information processing apparatus according to claim 2, wherein
the extraction unit extracts a plane as the geometric element from the three-dimensional data, and
the coordinate system setting unit sets a first reference axis based on the normal direction of the plane extracted by the extraction unit, and sets an origin based on the centroid of a point cloud constituting the plane extracted by the extraction unit.

8. The information processing apparatus according to claim 7, wherein
the coordinate system setting unit sets a second reference axis based on a distribution of the point cloud constituting the plane extracted by the extraction unit.

9. The information processing apparatus according to claim 4, wherein
the extraction unit extracts at least one of cylinder and cone as three-dimensional shapes as the geometric elements from the three-dimensional data, and
the coordinate system setting unit specifies a first reference axis based on the three-dimensional shape extracted by the extraction unit, and sets an origin based on a centroid of a point cloud constituting the three-dimensional shape extracted by the extraction unit.

10. The information processing apparatus according to claim 1, wherein
the analysis unit performs a dimension analysis of a cross section of the three-dimensional data of the workpiece, the cross section being a plane intersecting with one reference axis set by the coordinate system setting unit.

11. The information processing apparatus according to claim 10,
the analysis unit determines a position of the cross section based on the centroid of the workpiece.

12. The information processing apparatus according to claim 11, wherein
the analysis unit accepts adjustment of the position of the cross section by a user.

13. The information processing apparatus according to claim 1, wherein
the coordinate system setting unit sets a plurality of reference axes based on the specified rule and the geometric elements extracted by the extraction unit, and
the analysis unit projects the three-dimensional data of the workpiece onto a reference plane determined by the plurality of reference axes set by the coordinate system setting unit, and performs dimension analysis of the projected three-dimensional data obtained by the projection.

14. An information processing method for analyzing three-dimensional data of a workpiece with a predetermined coordinate system set, the method comprising:
storing in advance a rule set in a storage unit, the rule set associating a plurality of types of geometric elements used for creating a coordinate system with information for creating a coordinate system based on each type of geometric element;
acquiring three-dimensional data of the workpiece;
extracting geometric elements from the acquired three-dimensional data of the workpiece;
identifying the type of the extracted geometric elements;
identifying one rule from the rule set stored in the storage unit based on the identified type of geometric elements, and setting a reference coordinate system based on the identified one rule and the extracted geometric elements; and
performing analysis of the three-dimensional data of the workpiece based on the set reference coordinate system.

15. A storage medium storing an information processing program that causes a computer to execute information processing for analyzing three-dimensional data of a workpiece in which a predetermined coordinate system is set, the computer comprising:
a storage unit that stores in advance a rule set associating a plurality of types of geometric elements used for creating a coordinate system with information for creating a coordinate system based on each type of geometric element;
a processor; and
a memory storing an information processing program configured to be executed by the processor, the information processing program including instructions for:
acquiring three-dimensional data of the workpiece;
extracting geometric elements from the acquired three-dimensional data of the workpiece;
identifying types of the extracted geometric elements;
identifying one rule from the rule set stored in the storage unit based on the identified types of geometric elements;
setting a reference coordinate system based on the identified rule and the extracted geometric elements; and
performing analysis of the three-dimensional data of the workpiece based on the set reference coordinate system.
